(19) United States
(12) Patent Application Publication
(10) Pub. No.: US 2026/0335883 A1
(43) Pub. Date: Oct. 29, 2026

(54) PLASTIC-BASED ANALYTICAL MICROFLUIDIC BIOCHIPS

(71) Applicant: GEORGIA TECH RESEARCH CORPORATION, Atlanta, GA (US)

(72) Inventors: Ali Fatih SARIOGLU, Atlanta, GA (US); AKM ARIFUZZMAN, Atlanta, GA (US); Norh ASMARE, Atlanta, GA (US); Ahmadreza ROSTAMZADEH, Atlanta, GA (US)

(21) Appl. No.: 19/647,402

(22) Filed: Apr. 14, 2026

Related U.S. Application Data
(60) Provisional application No. 63/788,796, filed on Apr. 14, 2025.

(51) Int. Cl. B01L 3/00

(52) U.S. Cl. CPC B01L 3/502715; B01L 3/502707; B01L 2200/12; B01L 2300/0663; B01L 2300/0887; B01L 2300/12

(57) ABSTRACT

An exemplary system and method for a scalable, low-cost polymer-made microfluidic device for scalable, low-cost production, the polymer-made microfluidic device comprising a set of metal electrodes formed on a polymer substrate to measure the electrical and mechanical properties of the biological cells, the polymer-made microfluidic device having chambers configured to capture or immobilize target cells with biomolecules functionalized in the chambers. The exemplary system and method are enabled by a method of fabrication that allows the deposition and patterning of metal electrodes on low-cost polymers such as polycarbonate, the electrodes being lithographically patterned and etched to have etched electrode features having less than 10 μm in size.

### RELATED APPLICATION

This application claims priority to, and the benefit of U.S. Provisional Patent Application No. 63/788,796, filed Apr. 14, 2025, entitled “PLASTIC-BASED ANALYTICAL MICROFLUIDIC BIOCHIPS,” which is incorporated by reference herein in its entirety.

### BACKGROUND

Immunophenotyping plays a central role in modern biomedical research and clinical diagnostics by enabling the identification and characterization of specific cell populations based on their surface markers. The most widely used technology for this purpose is flow cytometry, which provides high-throughput, multiparametric analysis of individual cells through optical detection methods. Despite its powerful capabilities, conventional flow cytometry relies on complex and bulky instrumentation, including fluidic control systems, optical components, and high-sensitivity detectors. These systems are expensive, require specialized operation, and are typically confined to centralized laboratory environments, limiting their accessibility in resource-limited settings or point-of-care applications.

Microfluidic devices have emerged as a platform for miniaturizing cellular analysis systems by manipulating small volumes of fluids within microscale channels. Microfluidic devices offer several advantages over conventional instrumentation, including reduced reagent consumption, precise fluid control, and the potential for integration of multiple functionalities on a single chip. Over the past two decades, numerous microfluidic approaches have been developed for cell sorting, counting, and immunophenotyping, demonstrating the potential for portable and low-cost alternatives to traditional cytometry platforms.

However, many microfluidic systems are fabricated using elastomeric materials such as polydimethylsiloxane (PDMS), which, while convenient for rapid prototyping, presents many limitations for scalable manufacturing and practical deployment. PDMS devices typically rely on soft lithography processes that are difficult to scale to large production volumes and can suffer from issues such as mechanical fragility, solvent incompatibility, and device-to-device variability.

There is a benefit to improving the manufacturing of microfluidic systems with thermoplastics or other polymers.

### SUMMARY

An exemplary system and method are disclosed, and method of fabrication, for a scalable, low-cost polymer-made microfluidic device for scalable, low-cost production, the polymer-made microfluidic device comprising a set of metal electrodes formed on a polymer substrate to measure the electrical and mechanical properties of the biological cells, the polymer-made microfluidic device having chambers configured to capture or immobilize target cells with biomolecules functionalized in the chambers. The exemplary system and method are enabled by a method of fabrication that allows the deposition and patterning of metal electrodes on low-cost polymers such as polycarbonate, the electrodes being lithographically patterned and etched to have etched electrode features having less than 10 μm in size.

While many designs of microfluidic devices have been developed for immunophenotyping, cell sorting, cell capture, among other microfluidic functions described herein that employ metal or metal alloy electrodes, the fabrication of such microfluidic devices is limited to materials such as glass due to the lack of capabilities to form the metal electrodes on low-cost polymers such as polycarbonate. The exemplary fabrication operation employs (i) lithographic and etching processes to form electrodes having been lithographically patterned with a positive photoresist and etched to have etched electrode features having less than 10 μm in size in combination with (ii) a solvent-less or plasma-less UV-based flood exposure process to remove the photoresist in the lithographic and etching processes. The lack of the use of solvents or plasma in the photoresist removal allows lithography and etching processes to be utilized in combination with photoresist patterning on low-cost polycarbonate and other thermoplastics, which would otherwise be damaged by solvents or plasma when removing the photoresist during the fabrication.

Thermoplastic materials can be fabricated using high-volume and low-cost methods such as hot embossing, injection molding, and compression molding, which are widely used in the mass production of microstructured components. These approaches allow microfluidic devices to be produced with high reproducibility and significantly lower per-unit cost, making them more suitable for widespread deployment in diagnostic and research applications.

In addition to material choice, modular device architectures offer further advantages by allowing different functional components of a microfluidic system to be fabricated independently and later integrated into a unified platform. Such modular designs enable combining components that require different fabrication processes while also simplifying system expansion and adaptation to new applications.

In some embodiments, the exemplary system can have at least two layers. Microfluidic channels of the exemplary device can be patterned onto its first layer (e.g., plastic substrate, sensor plate) using molding/stamping techniques, enabling rapid and reproducible replication of channel geometries. Cell counting electrodes of the exemplary device can be deposited onto a secondary layer using lithographic means such as electron-beam lithography and enumerate every cell that enters and leaves each capture microchamber. These two layers can then be bonded to produce robust, leak-free microfluidic biochips capable of counting and analyzing cells.

Current state-of-the-art microfluidic devices can be constructed from plastic materials, requiring expensive tooling and expertise, which can form metal structures on polymer of up to 10 μm in size. In addition, while such costs are offset by high production volume and low unit cost, early-stage development of the current state-of-the-art devices can face challenges as the production volumes are too low to justify the high non-recurring engineering costs. To address this, the exemplary device is developed as a scalable and cost-effective microfluidic device using widely available plastic materials.

In an aspect, a multi-layer microfluidic device is disclosed comprising a polymer substrate (e.g., polycarbonate substrate) having a surface or a channel surface comprising at least two metal electrodes lithographically patterned thereon, including a first electrode and a second electrode, wherein the first electrode and the second electrode are formed of one or more metal layers deposited on the polymer substrate and lithographically patterned and etched to have etched electrode features having less than 10 μm in size; and a microfluidic portion (e.g., multi-layer portion) fixably coupled to the polymer substrate to form the multi-layer microfluidic device, the microfluidic portion having a set of channels and patterns formed via a molding process to form (i) a plurality of microfluidic channels and (ii) one or more internal volumes defining one or more chambers, including a first chamber, wherein the first chamber has chamber structures (e.g., walls, pillars, posts, holes) functionalized for cell capture, cell sorting, or immunophenotyping of a sample (e.g., having target cells and non-target cells), wherein the first electrode is disposed at an inlet of the first chamber, and wherein the second electrode is disposed at an outlet of the first chamber.

In some embodiments, the first electrode and the second electrode each comprise a metal stack comprising two or more metals (e.g., a gold-titanium stack, platinum, chromium nickel, copper, and aluminum).

In some embodiments, the first electrode is connected via a first tracing to a first electrode pad all formed of the one or more metal layers deposited on the polymer substrate and lithographically patterned and etched to form the first tracing and the first electrode pad, and wherein the second electrode is connected via a second tracing to a second electrode pad all formed of the one or more metal layers deposited on the polymer substrate and lithographically patterned and etched to form the second tracing and the second electrode pad.

In some embodiments, the first chamber includes antibody-functionalized micropillars to (i) selectively immobilized a target cell, as the chamber structures functionalized for cell capture, cell sorting, or immunophenotyping when a sample, comprising target and non-target cells, flows through the first chamber, and wherein the first electrode disposed at the inlet of the first chamber and the second electrode are each configured to be interrogated, by an electric circuit (e.g., located on the multi-layer microfluidic device or external to the multi-layer microfluidic device), to provide a first impedance-based measurement and a second impedance-based measurement in an impedance-based counting operation (e.g., wherein the number of captured cells or non-captured cells are determined by differential counting between the first and second measurements).

In some embodiments, the chamber structures (e.g., walls, pillars, posts, holes) are functionalized by a biomolecule selected from the group consisting of avidin, thiol, cyclooctyne, polydopamine/protein G, azide, and a combination thereof.

In some embodiments, the polymer substrate is formed of a polymer selected from the group consisting of a polycarbonate (PC), a Cyclic Olefin Copolymer (COC), and a polyethylene tetraphthalate (PET).

In some embodiments, the microfluidic portion is made of polymer selected from the group consisting of a polystyrene (PS), a polycarbonate (PC), a Cyclic Olefin Copolymer (COC).

In some embodiments, the device further includes a second chamber, wherein the polymer substrate includes a third electrode and a fourth electrode, wherein the third electrode and the fourth electrode are formed of one or more metal layers deposited on the polymer substrate and lithographically patterned and etched to have etched electrode features having less than 10 μm in size, wherein the microfluidic portion, having the set of channels and patterns formed via the molding process, forms the second chamber, and wherein the third electrode is disposed at an inlet of the second chamber, and wherein the fourth electrode is disposed at an outlet of the second chamber.

In some embodiments, at least two of the first, second, third, and fourth electrodes are connected to one another via the first electrode pad and the second electrode pad for multiplexed interrogation of cells in the sample for multiplexed counting.

In some embodiments, the first chamber and a second chamber are configured in a series configuration, a parallel configuration, or a combination of both series and parallel configurations (e.g., a grid).

In some embodiments, at least one of the first electrode and the second electrode is measure electrical properties and mechanical properties of cells of the sample.

In some embodiments, the device further includes an array of chambers, including the first chamber, wherein the polymer substrate includes an upstream electrode and a downstream electrode for each chamber of the array of chambers, wherein each upstream electrode and each downstream electrode for each respective chamber of the array of chambers are formed of one or more metal layers deposited on the polymer substrate and lithographically patterned and etched to have etched electrode features having less than 10 μm in size.

In some embodiments, the first electrode and the second electrode are formed of one or more metal layers deposited on the polymer substrate and lithographically patterned and etched via the use of a positive photoresist and UV curing process.

In some embodiments, the microfluidic portion is formed of a molding process selected from the group consisting of hot embossing, injection molding, and compression molding.

In some embodiments, the first electrode comprises a set of interdigitated electrode portions, wherein electrode spacings or spacings between the interdigitated electrode portions, as the electrode features, are lithographically patterned and etched to have etched electrode features having less than 10 μm in size.

In another aspect, a method is disclosed of fabricating a multi-layer polymer microfluidic device, the method includes forming a polymer substrate (e.g., polycarbonate substrate) having a surface or a channel surface comprising at least two metal electrodes lithographically patterned thereon, including a first electrode and a second electrode, wherein the first electrode and the second electrode are formed of one or more metal layers deposited on the polymer substrate and lithographically patterned and etched to have etched electrode features having less than 10 μm in size, the forming comprising: (i) depositing the one or more metal layers on the polymer substrate as a workpiece; (ii) applying a photoresist over a top surface of one or more metal layers of the workpiece; (iii) lithographically patterning the photoresist to define the at least two metal electrodes lithographically patterned on the surface or a channel surface of the workpiece; (iv) wet etching the workpiece to at least define the first electrode and the second electrode; and (iv) applying ultraviolet flood exposure to remove the photoresist without use of a solvent or plasma.

The method includes forming, via a molding process, a microfluidic portion having a set of channels and patterns; wherein the molding process is selected from the group consisting of hot embossing, injection molding, and compression molding; and fixably coupling the polymer substrate and the microfluidic portion to form the multi-layer microfluidic device, wherein the polymer substrate and the microfluidic portion couple to form (i) a plurality of microfluidic channels and (ii) one or more internal volumes defining one or more chambers, including a first chamber, wherein the first chamber has chamber structures (e.g., walls, pillars, posts, holes) functionalized for cell capture, cell sorting, or immunophenotyping of a sample (e.g., having target cells and non-target cells), and wherein the first electrode is disposed at an inlet of the first chamber, and wherein the second electrode is disposed at an outlet of the first chamber.

In some embodiments, the applied photoresist is a positive photoresist that is sensitive to ultraviolet light.

In some embodiments, the method further includes, prior to fixably coupling the polymer substrate and the microfluidic portion to form the multi-layer microfluidic device, applying a biomolecule to the chamber structures (e.g., walls, pillars, posts, holes) functionalized for cell capture, cell sorting, or immunophenotyping, wherein the biomolecule is selected from the group consisting of avidin, thiol, cyclooctyne, polydopamine/protein G, azide, and a combination thereof.

In some embodiments, the first electrode and the second electrode each comprise a metal stack comprising two or more metals (e.g., a gold-titanium stack, platinum, chromium nickel, copper, and aluminum).

In some embodiments, the polymer substrate is formed of a polymer selected from the group consisting of a polycarbonate (PC), a Cyclic Olefin Copolymer (COC), and a polyethylene tetraphthalate (PET), and wherein the microfluidic portion is made of polymer selected from the group consisting of a polystyrene (PS), a polycarbonate (PC), a Cyclic Olefin Copolymer (COC).

### BRIEF DESCRIPTION OF THE DRAWINGS

FIG. 1A shows an example scalable, low-cost polymer-made microfluidic device comprising a set of metal electrodes formed on a polymer substrate to measure the electrical and mechanical properties of the biological cells, the polymer-made microfluidic device having chambers configured to capture or immobilize target cells with biomolecules functionalized in the chamber, in accordance with an illustrative embodiment.

FIGS. 1B and 1C show a method of fabricating a multi-layer polymer microfluidic device of FIG. 1A in accordance with an illustrative embodiment.

FIGS. 2A-2D each show an exemplary device that uses a microchamber and embedded sensing electrodes in accordance with an illustrative embodiment.

FIG. 2E shows interdigitated electrodes that form a network of coded Coulter sensor that facilitate the electrical measurement of a number of captured cells in each of the functionalized cell capture chambers in accordance with an illustrative embodiment.

FIGS. 3A, 3B, 3C, 3D, 4A, and 4B each show an example method of fabricating a scalable, low-cost polymer-made microfluidic device in accordance with an illustrative embodiment in accordance with an illustrative embodiment.

FIG. 5A shows an example microfluidic device configured to perform immunophenotyping on biological cells with surface markers in accordance with an illustrative embodiment.

FIGS. 5B and 5C each show an example modular plastic microfluidic biochip designed for electrical immunophenotyping of cells based on differential cell counting in accordance with an illustrative embodiment.

FIGS. 5D and 5E show an example programmable modular microfluidic platform for configurable cell analysis workflows, as well as example workflows for cell processing and analysis in accordance with an illustrative embodiment.

FIGS. 5F and 5G show serial and parallel assembly of modular microfluidic units enabling multiplexed cell processing and phenotyping in accordance with an illustrative embodiment. FIGS. 6A and 6B each show an example device fabrication and assembly for a modular microfluidic device in accordance with an illustrative embodiment.

FIGS. 7A, 7B, 7C, 7D, 7E, 7F, 7G, and 7H show experimental or simulation results from a study conducted to develop a modular microfluidic device in accordance with an illustrative embodiment.

### DETAILED DESCRIPTION

Some references, which may include various patents, patent applications, and publications, are cited in a reference list and discussed in the disclosure provided herein. The citation and/or discussion of such references is provided merely to clarify the description of the disclosed technology and is not an admission that any such reference is “prior art” to any aspects of the disclosed technology described herein. In terms of notation, “[n]” corresponds to the nth reference in the list. For example, [1] refers to the first reference in the list. All references cited and discussed in this specification are incorporated herein by reference in their entirety and to the same extent as if each reference was individually incorporated by reference.

### Example System

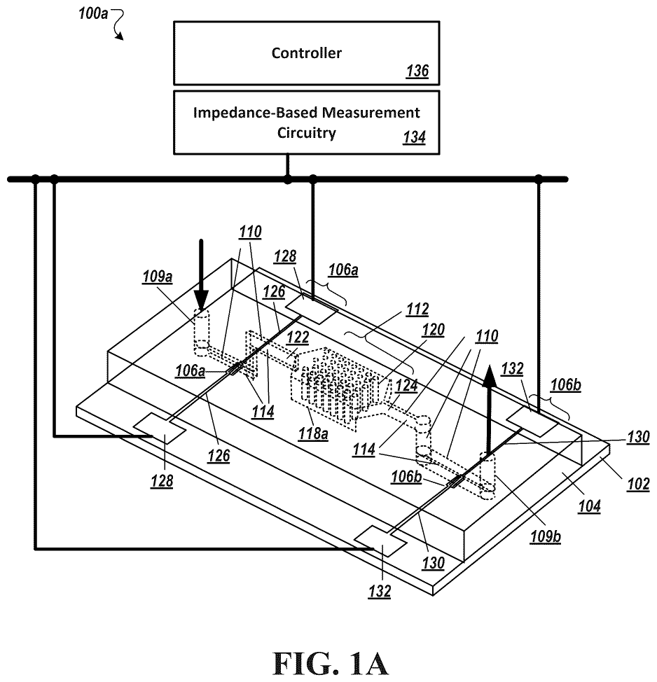

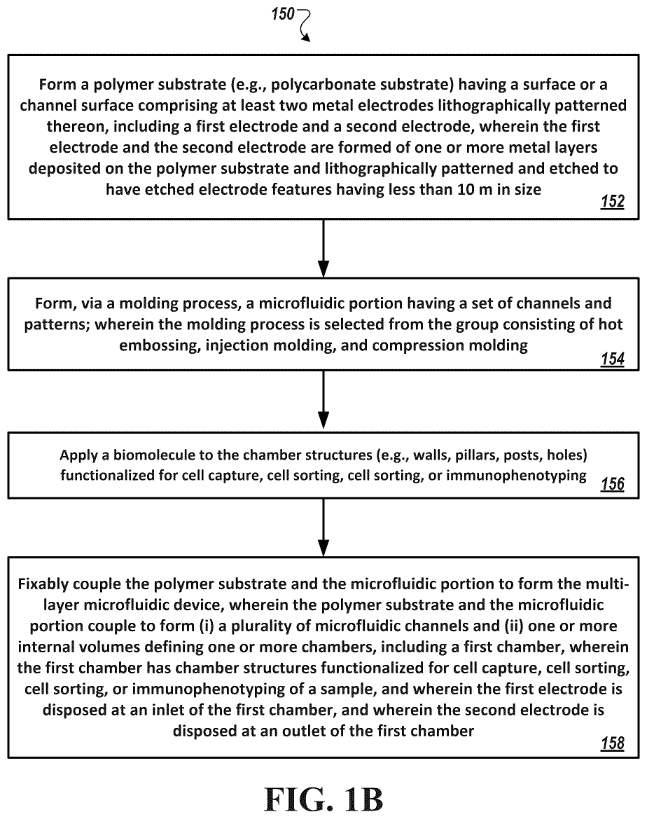

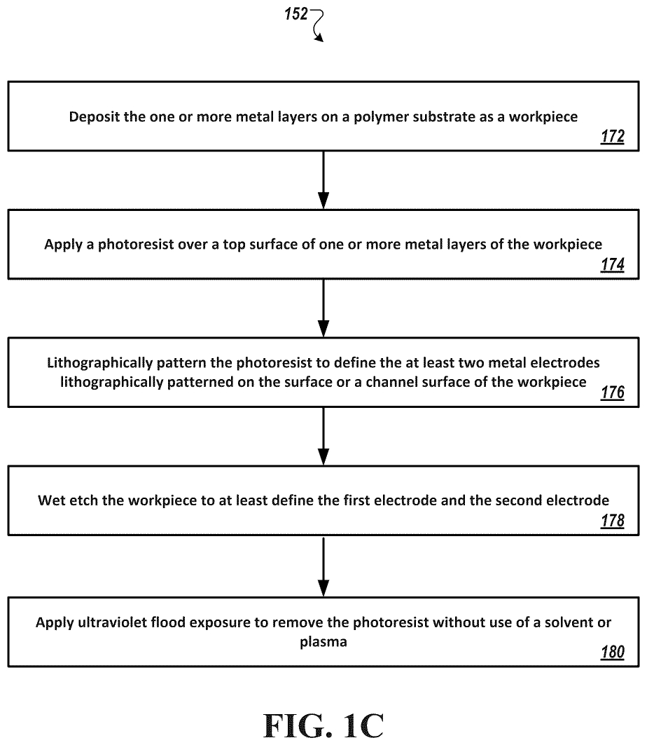

FIG. 1A shows an example scalable, low-cost polymer-made microfluidic device 100 (shown as 100a) comprising a set of metal electrodes formed on a polymer substrate to measure the electrical and mechanical properties of the biological cells, the polymer-made microfluidic device 100a having chambers configured to capture or immobilize target cells with biomolecules functionalized in the chamber, in accordance with an illustrative embodiment.

In the example shown in FIG. 1A, the multi-layer microfluidic device 100a includes a polymer substrate 102 and a microfluidic portion 104 implemented in a set of layers.

Polymer Substrate with Electrodes.

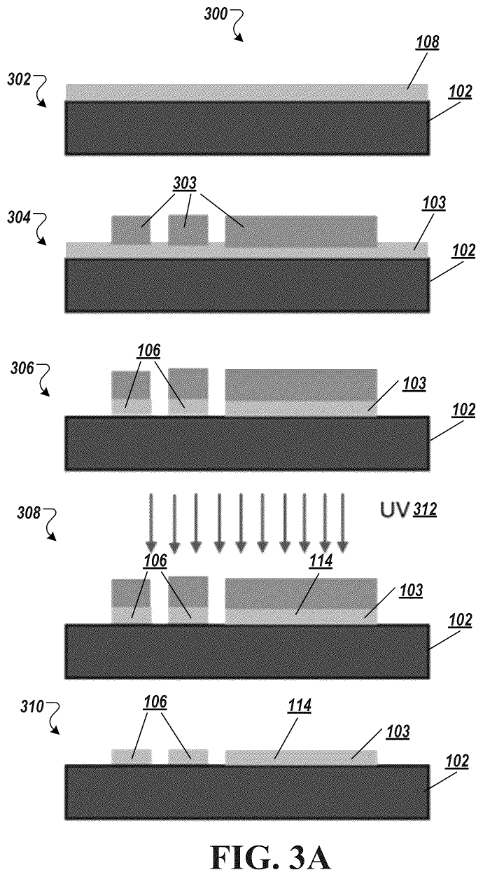

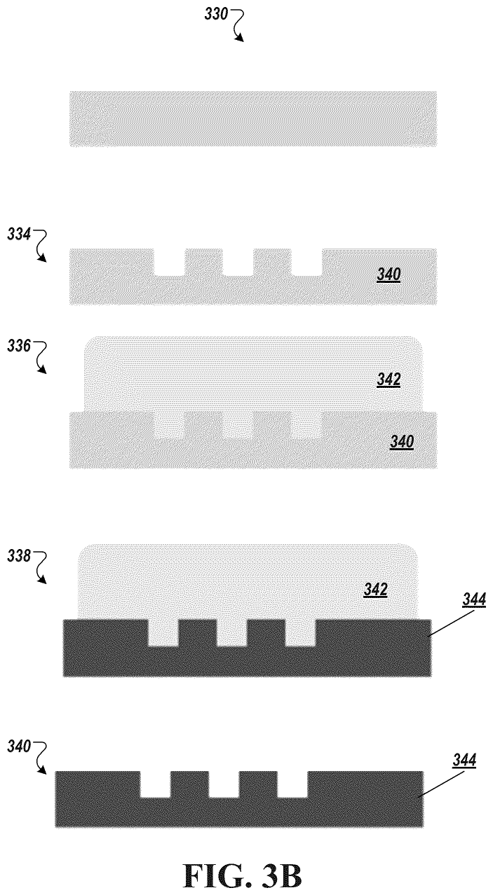

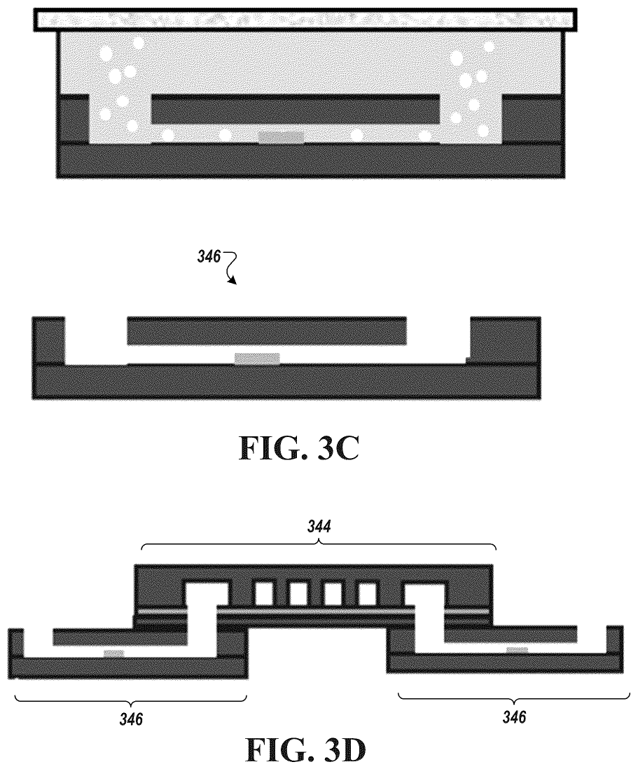

The polymer substrate 102 (e.g., one or more layers forming a polycarbonate substrate) includes a surface or a channel surface comprising at least two metal electrodes 106 lithographically patterned thereon, including a first electrode 106a and a second electrode 106b. The first electrode 106a and the second electrode 106 are formed of one or more metal layers 108 (not shown, see FIG. 3) deposited on the polymer substrate 102 and lithographically patterned and etched to have etched electrode features having less than 10 μm in size. The polymer substrate 102 is preferably formed of a polymer selected from the group consisting of a polycarbonate (PC), a Cyclic Olefin Copolymer (COC), and a polyethylene tetraphthalate (PET).

### Polymer Microfluidic Portion.

The microfluidic portion 104 (e.g., having one or more multi-layer portions) is fixably coupled to the polymer substrate 102 to form the multi-layer microfluidic device 100a. The microfluidic portion 104 has an inlet 109a, an output 109b, and a set of channels 110 and patterns 112 formed via a molding process to form (i) a plurality of microfluidic channels 114 and (ii) one or more internal volumes defining one or more chambers 118, including a first chamber 118a. The first chamber 118a has chamber structures 120 (e.g., walls, pillars, posts, holes) functionalized for cell capture, cell sorting, or immunophenotyping of a sample (e.g., having target cells and non-target cells). The first electrode 106a is disposed at an inlet 122 of the first chamber 118a, and the second electrode 106b is disposed at an outlet 124 of the first chamber 118a. The microfluidic portion 104 is preferably made of a polymer selected from the group consisting of polystyrene (PS), polycarbonate (PC), and Cyclic Olefin Copolymer (COC).

The microfluidic portion 104 may be formed by a molding process selected from the group consisting of hot embossing, injection molding, and compression molding. Hot embossing molds may be used to transfer designs, textures, or microstructures onto a plastic as the microfluidic portion 104, using heat and pressure. Hot embossing molds are often made from materials with high thermal conductivity and durability, such as brass, copper, or magnesium. Injection molding produces high-volume, consistent plastic parts by injecting molten material into a mold. Compression molding is a high-pressure, heated manufacturing process that forms materials (e.g., thermoset plastics, composites) into complex shapes by compressing a preheated charge between two mold halves.

### Electrodes.

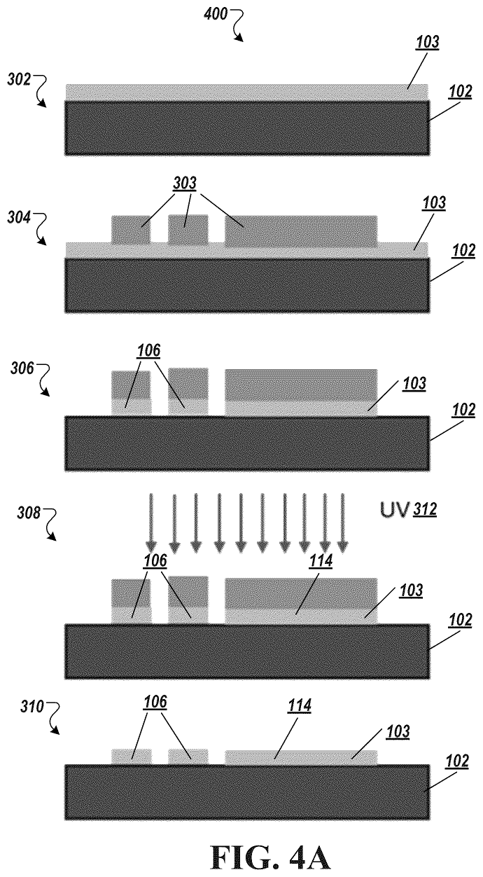

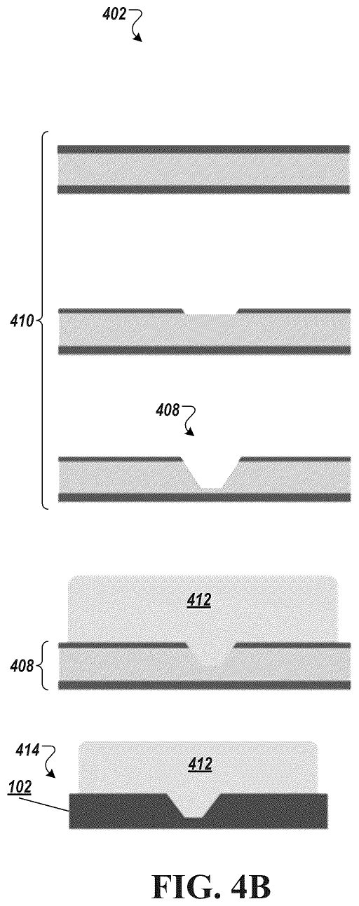

The first electrode 106a and the second electrode 106b may each be formed of a metal stack, e.g., comprising two or more metals or metal alloys (e.g., a gold-titanium stack, platinum, chromium nickel, copper, and aluminum) (see, e.g., FIGS. 3A, 4A, 5B, 6A, 6B). The electrodes 106 may be employed to measure the electrical properties and mechanical properties of cells of the sample. The first electrode 106a and the second electrode 106b may be formed of one or more metal layers deposited on the polymer substrate 106 and lithographically patterned and etched via the use of a positive photoresist and UV curing process, e.g., as described in relation to FIGS. 3 and 4.

In FIG. 1A, the electrodes 106a, 106b are employed for differential cell counting. The first electrode 106a is connected via a first tracing 126 to a first electrode pad 128 all formed of the one or more metal layers deposited on the polymer substrate and lithographically patterned and etched to form the first tracing and the first electrode pad. The second electrode 106b is connected via a second tracing 130 to a second electrode pad 132, all formed of one or more metal layers deposited on the polymer substrate and lithographically patterned and etched to form the second tracing and the second electrode pad.

In some embodiments, the electrodes 106 are interdigitated, having interdigitated electrode portions where electrode spacings or spacings between the interdigitated electrode portions, as the electrode features, are lithographically patterned and etched to have etched electrode features having less than 10 μm in size.

In some embodiments, the electrodes 106 are arranged in a parallel, opposing configuration across the channel height to generate a substantially uniform electric field, thereby reducing position-dependent variability and improving the accuracy and robustness of impedance-based measurements.

As shown in the example of FIG. 1A, the first chamber 118a includes antibody-functionalized micropillars to (i) selectively immobilize a target cell, as the chamber structures are functionalized for cell capture, cell sorting, or immunophenotyping when a sample, comprising target and non-target cells, flows through the first chamber 118a.

### Instrumentation.

The first electrode 106a and the second electrode 106b are each configured to be interrogated by an electric circuit 134 (shown as “Impedance-based Measurement Circuitry” 134). The impedance-based measurement circuitry 134 is coupled to a controller 136 configured to evaluate the cell capture, cell sorting, cell identification, quantification, and/or immunophenotyping.

The impedance-based measurement circuitry 134 and the controller 136 may be located on or in the multi-layer microfluidic device 100a, or external to the multi-layer microfluidic device 100a, to provide an impedance-based measurement. Each electrode 106 may be configured to be independently readable to enable the selective acquisition of signals from different chambers. Signals from spatially distributed electrodes may be used to extract spatial and temporal information, including cell position and speed within the device. As an example, an impedance-based counting operation may provide a number of captured cells or non-captured cells, e.g., determined by differential counting between the first and second measurements. In the example shown in FIG. 1A, the electrodes 106 are connected to one another via the electrode pads (e.g., 128, 132) for multiplexed interrogation of cells in the sample for multiplexed counting.

### Functionalized Chambers and Chamber Configurations.

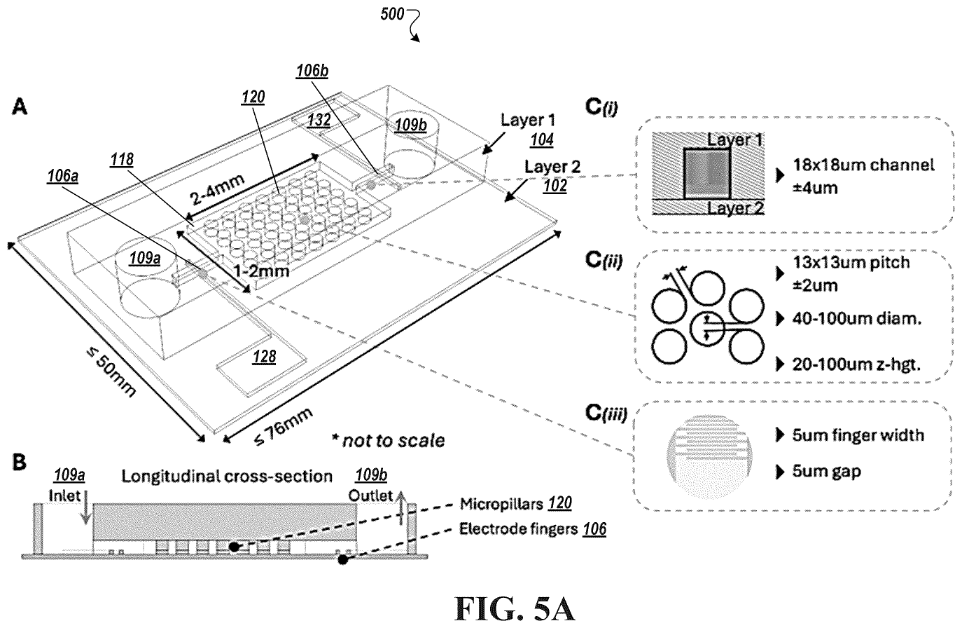

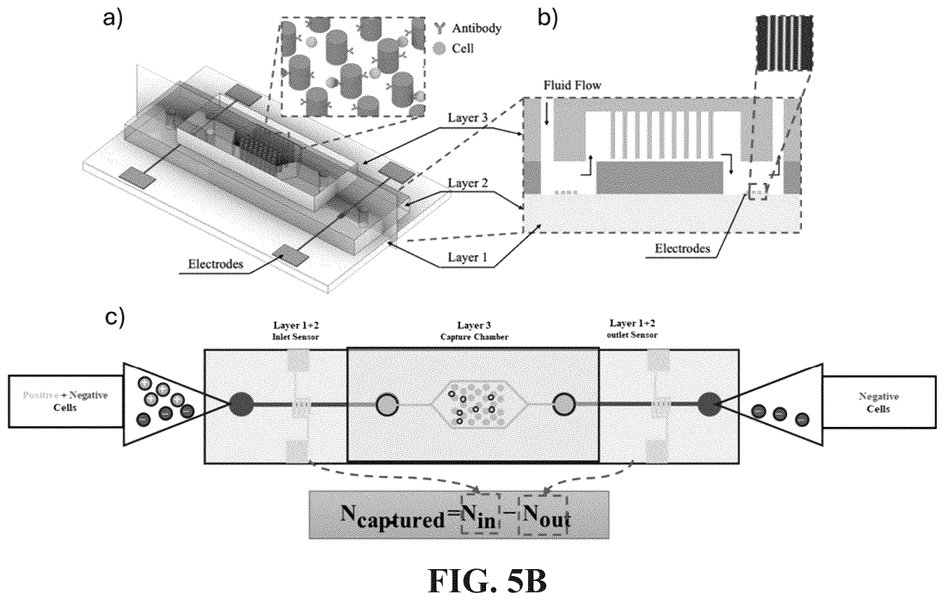

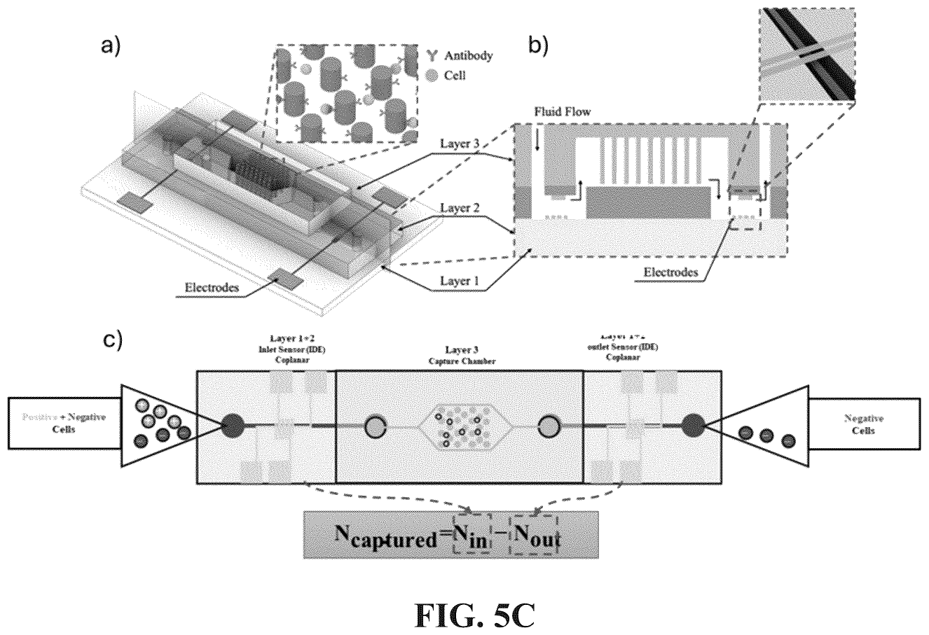

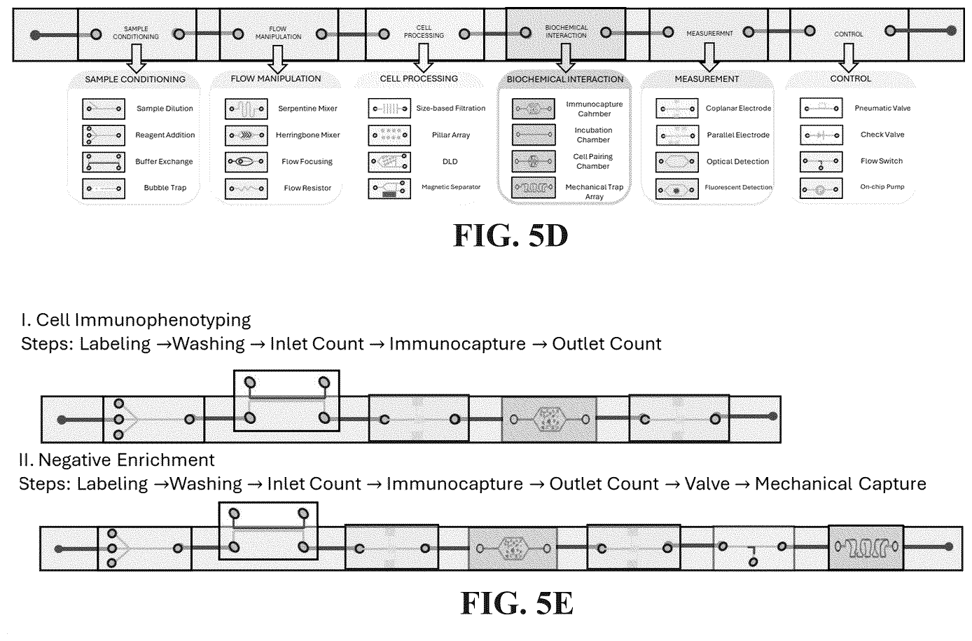

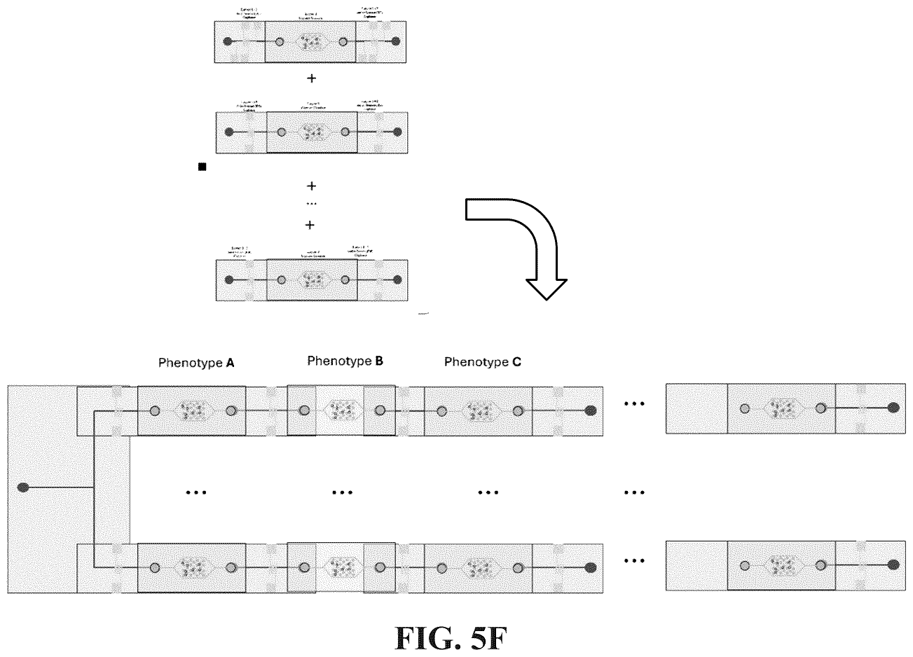

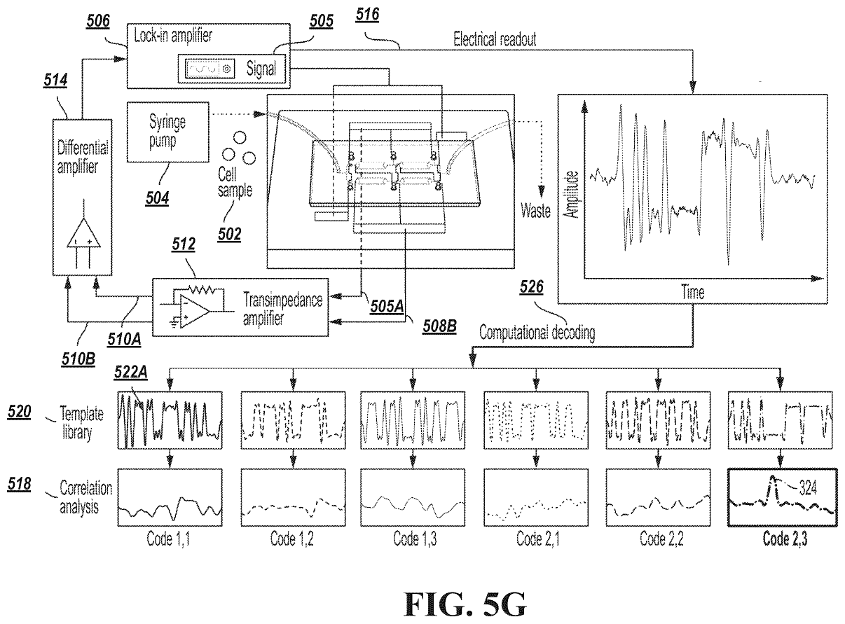

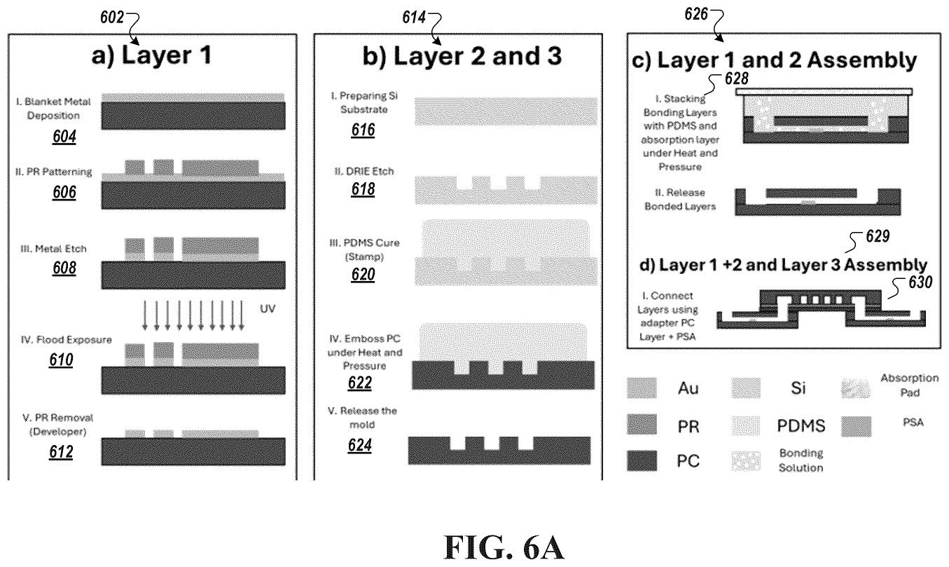

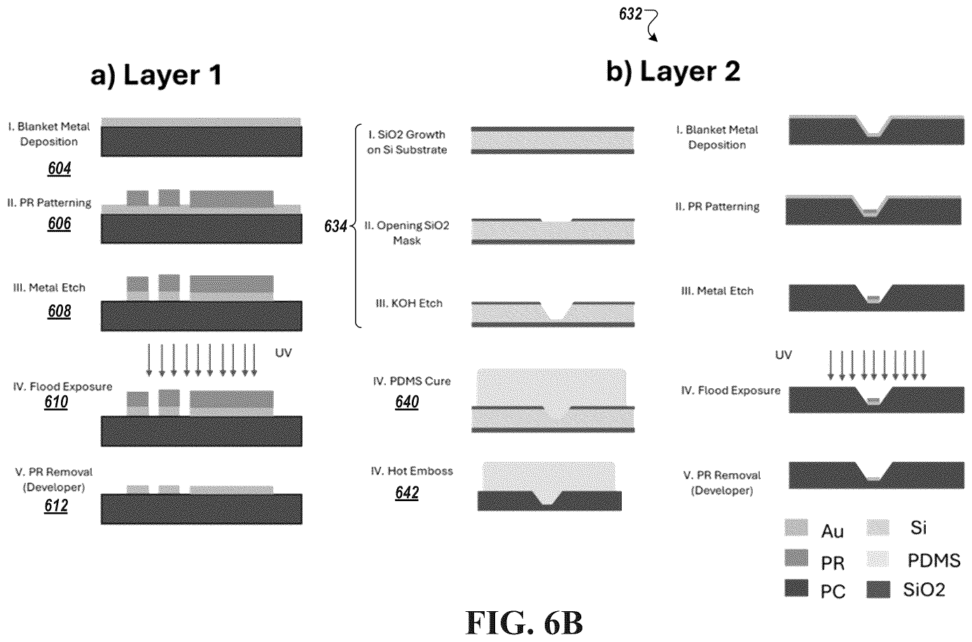

The chamber structures 120 may be functionalized by a biomolecule selected from the group consisting of avidin, thiol, cyclooctyne, polydopamine/protein G, azide, and a combination thereof. In some embodiments, the functionalized chamber structure may include walls, pillars, posts, holes, or other flow protruding structures in the chamber 118a. The chambers 18 may be configured as an array of chambers (e.g., see FIG. 5D).

The channels 114, in some embodiments, are functionalized with a functional coating.

In some embodiments, the device 100 may include additional chambers 118, e.g., located in parallel or serial to the first chamber 118a. Each of the chambers 118 may be configured with one or more electrodes to provide counting or quantification of the cells in the sample, e.g., prior to and/or after that chamber. In some embodiments, each chamber 118 may include an electrode 106 that is formed of one or more metal layers deposited on the polymer substrate 102 and lithographically patterned and etched to have etched electrode features having less than 10 μm in size. In some embodiments, the polymer substrate 102 includes an upstream electrode (e.g., 106a) and a downstream electrode (e.g., 106b) for each chamber 118 of the array of chambers 118. Each upstream electrode 106a and each downstream electrode 106b for each respective chamber 118 of the array of chambers may be formed of one or more metal layers deposited on the polymer substrate and lithographically patterned and etched to have etched electrode features having less than 10 μm in size.

### Example Method of Fabrication

FIGS. 1B and 1C show a method 150 of fabricating a multi-layer polymer microfluidic device (e.g., 100), e.g., as described in relation to FIG. 1A, in accordance with an illustrative embodiment. Method 150 includes forming (152) a polymer substrate (e.g., 102) (e.g., polycarbonate substrate) having a surface or a channel surface comprising at least two metal electrodes lithographically patterned thereon, including a first electrode (e.g., 106a) and a second electrode (e.g., 106b), where the first electrode (e.g., 106a) and the second electrode (e.g., 106b) are formed of one or more metal layers (e.g., 108) deposited on the polymer substrate 102 and lithographically patterned and etched to have etched electrode features having less than 10 μm in size.

As shown in FIG. 1C, the forming 152 may includes depositing (172) the one or more metal layers on the polymer substrate as a workpiece, applying (174) a photoresist over a top surface of one or more metal layers of the workpiece, lithographically patterning (176) the photoresist to define the at least two metal electrodes lithographically patterned on the surface or a channel surface of the workpiece. wet etching (178) the workpiece to at least define the first electrode and the second electrode, and applying (180) ultraviolet flood exposure to remove the photoresist without the use of a solvent or plasma. The applied photoresist is a positive photoresist that is sensitive to ultraviolet light.

An example metal layer may be gold-titanium stack, platinum, chromium nickel, copper, and aluminum.

In using a positive photoresist and UV flood exposure, the fabrication operation can employ (i) lithographic and etching processes to form the electrodes 106. The lack of the use of solvents or plasma in the photoresist removal allows lithography and etching processes to be utilized in combination with photoresist patterning on low-cost polycarbonate and other thermoplastics, which would otherwise be damaged by solvents or plasma when removing the photoresist during the fabrication. Solvent-based photoresist removal processes often degrade or swell the polymer substrates. By avoiding solvents in the fabrication operation, thermoplastic materials can be employed as a material system for the device (e.g., 100) while preserving and/or ensuring structural integrity and surface properties. In addition, the use of ultraviolet flood exposure provides a faster and less damaging alternative to conventional plasma-based removal methods.

Referring back to FIG. 1B, Method 150 includes forming (154), via a molding process, a microfluidic portion (e.g., 104) having a set of channels and patterns; wherein the molding process is selected from the group consisting of hot embossing, injection molding, and compression molding. The polymer substrate (e.g., 102) may be formed of a polymer selected from the group consisting of a polycarbonate (PC), a Cyclic Olefin Copolymer (COC), and a polyethylene tetraphthalate (PET). The microfluidic portion (e.g., 104) may be made of polymer selected from the group consisting of a polystyrene (PS), a polycarbonate (PC), a Cyclic Olefin Copolymer (COC).

Method 150 then includes fixably coupling (158) the polymer substrate and the microfluidic portion to form the multi-layer microfluidic device, wherein the polymer substrate and the microfluidic portion couple to form (i) a plurality of microfluidic channels and (ii) one or more internal volumes defining one or more chambers, including a first chamber, wherein the first chamber has chamber structures (e.g., walls, pillars, posts, holes) functionalized for cell capture, cell sorting, or immunophenotyping of a sample (e.g., having target cells and non-target cells), and wherein the first electrode is disposed at an inlet of the first chamber, and wherein the second electrode is disposed at an outlet of the first chamber.

Prior to fixably coupling (158) the polymer substrate and the microfluidic portion to form the multi-layer microfluidic device, Method 150 includes applying (156) a biomolecule to the chamber structures (e.g., 120) (e.g., walls, pillars, posts, holes) functionalized for cell capture, cell sorting, or immunophenotyping. Biomolecule may be selected from the group consisting of avidin, thiol, cyclooctyne, polydopamine/protein G, azide, and a combination thereof.

### Example Multi-Layer Device

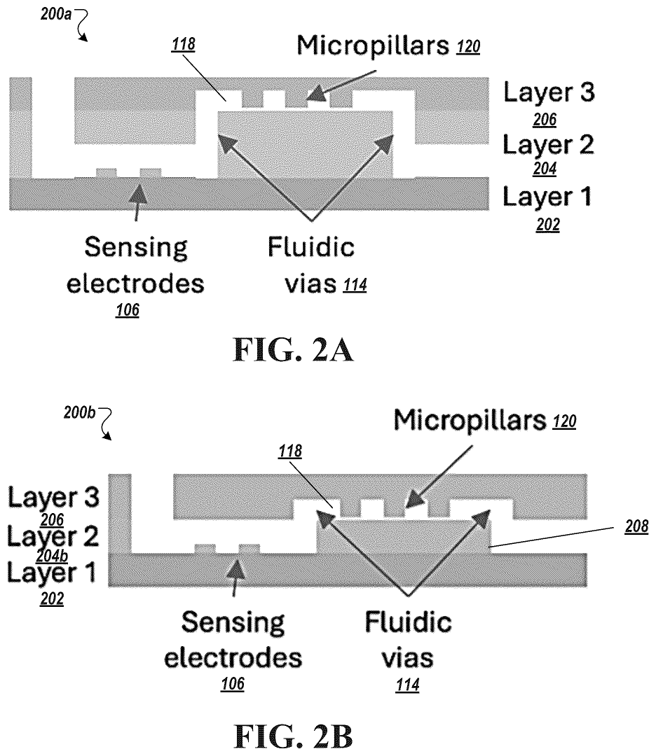

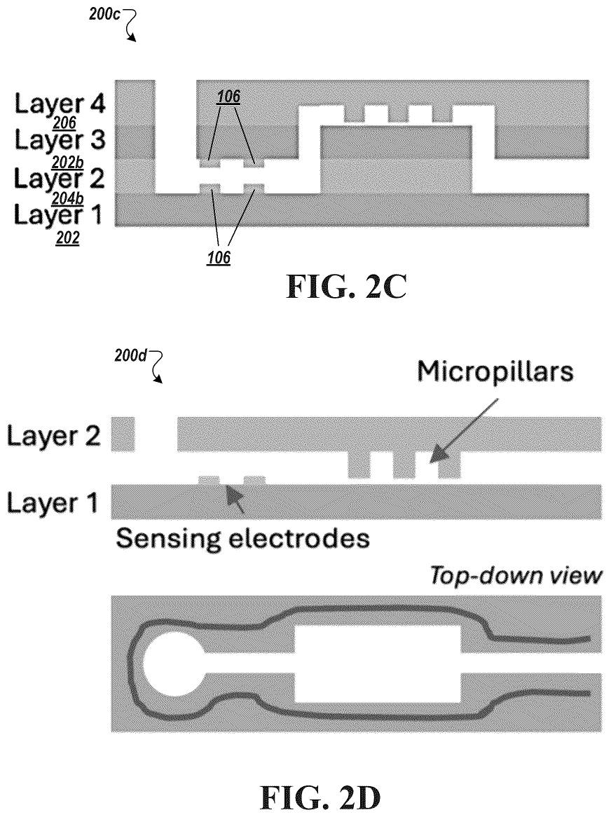

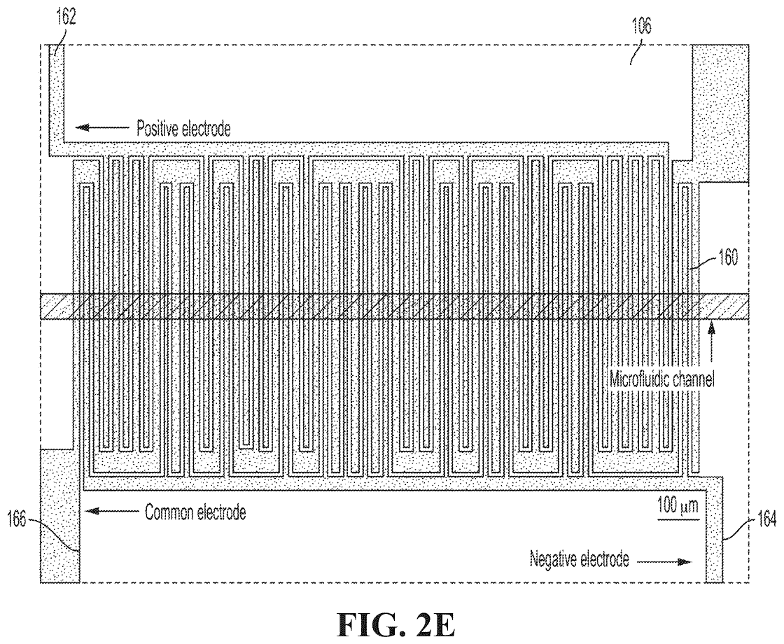

FIGS. 2A-2D each show an exemplary device 100 (shown as 200a, 200b, 200c) that uses a microchamber and embedded sensing electrodes. In FIG. 2A-2C, the exemplary devices 200a, 200b, 200c, 200d are configured with a three-layer structure, a dry-film resist structure, a four-layer structure, and a two-layer structure, respectively. While most plastic-based biochips rely on thermal/solvent-based diffusion bonding, the capture biomolecules in the microchamber and the embedded sensing electrodes limit the use of this standard procedure as they would experience performance degradation. In response, different construction schemes have been developed.

### 3-Layer Device.

In FIG. 2A, the example device 200a is configured with a three-layer plastic structure, separating sensitive components of the exemplary device (e.g., biomolecule-bearing microchamber 118) from durable components (e.g., feed/egress fluidic channels 114, sensing electrodes 106). In FIG. 2A, layer 1 (202) can be made of a durable plastic (e.g., polycarbonate (PC), Cyclic Olefin Copolymer (COC), polyethylene tetraphthalate (PET)) that can withstand lithographic processes and be micropatterned with sensing electrodes. Layer 2 (204) includes the inlet and feed channels that flow the cells in a single flow over sensing electrodes. The material selection for each layer can be dictated by compatibility with (i) thermal/solvent bonding with layer 1, (ii) available bonding techniques with layer 3 (206), and (iii) fabrication techniques to form the channels that feed/collect cells from layer 3 (206). Materials that meet these criteria can be polystyrene (PS), PC, or COC. Layer 3 (206) includes the capture microchamber (e.g., 118) configured with capture biomolecule-coated micropillars (e.g., 120). For this reason, layers 2 (204) and 3 (206) can be bonded using adhesive films or compatible solvent bonding techniques. Functionally, layer 3 can accept cells and return uncaptured cells to layer 2 using aligned fluidic vias during fabrication.

### Dry-Film Resist Device.

FIG. 2B shows an example device 200b configured with a dry-film resist structure (208) that can be photolithographically defined. In FIG. 2B, layer 1 (202) can be constructed from glass, PC, COC, or PET, layer 2 (204b) is the dry-film resist bearing the feed/egress channels, and layer 3 follows the same constraints as layer 3 in the three-layer plastic structure (shown in FIG. 2A).

### 4-Layer Device.

FIG. 2C shows an alternate embodiment to FIG. 2B as a 4-layer device 200c, where layers 1 (202) and 3 (202b) are identical, and their electrodes project into the feed/egress channels in layer 2 (204b). Layer 4 (206) follows the same constraints as layer 3 (202b) in the three-layer plastic structure (shown in FIG. 2A).

### 2-Layer Device.

FIG. 2D shows an example device 200d configured with a two-layer structure, wherein the two layers are sealed using mechanical or localized bonding means. In FIG. 2D (top), two layers are shown sealed by mechanically clamping them together. This clamping action can be implemented by constructing the layers to feature components that interlock with the other layer, such as snap-fit prongs. The two layers can also be secured together by external components, such as clamps or by bolting them down.

FIG. 2D (bottom) shows the two layers sealed by patterning a canal around the perimeter of the fluidic features (e.g., the feed/egress channels and the capture microchamber), wherein the bonding mechanism can be implemented (e.g., solvent, adhesive, etc.). The layer materials can be selected to be compatible with the bonding technique. The electrode-bearing layer 1 is constructed from glass, PC, COC, or PET, while the fluidic feature-bearing layer 2 follows the same constraints as layer 3 in the three-layer plastic structure (shown in FIG. 2A).

### Example Interdigitated Electrode

FIG. 2E shows interdigitated electrodes that form a network of coded Coulter sensor that facilitate the electrical measurement of a number of captured cells in each of the functionalized cell capture chambers. The sensing strategy may be based on the Microfluidic coded orthogonal detection by electrical sensing (CODES) scheme, which employs micromachined electrode patterns to multiplex spatiotemporal cell data across a microfluidic device. In an embodiment, a three-electrode Coulter counter may be shaped to form distinct electrode patterns (i.e., sensors) at six different nodes to monitor cell passage between microfluidic chambers. Each sensor may be composed of an array of 5 μm wide finger electrodes separated by 5 μm gaps and may produce a specific 31-bit digital code, which may be implemented by an interdigitated arrangement of three electrodes: two sensing electrodes to set the bit polarity (positive 162 for “1” and negative 164 for “0”) and one common electrode 166 meandering in between to excite the sensor network, as shown in FIG. 1 d. Cells flowing over one of these sensors may sequentially modulate the local impedance between adjacent finger electrodes via the Coulter principle and generated a distinct bipolar electrical waveform dictated by the surface electrode pattern. In addition, embodiments may use sensor codes designed to be mutually orthogonal (Gold sequences), and therefore, embodiments May 1) reliably discriminate sensor signals from each other in the output signal and 2) resolve interfering signals when multiple cells are coincidentally detected by the same or different sensors, for example, as shown in Table 1. Moreover, in the case of cell debris or aggregates, the electrical signal generated by sensors do not match any of the templates constructed based on single cell signals and therefore, these data are discarded and do not affect the assay performance.

Examples of Gold codes used in the multiplexed sensor network for the antibody microarray and the individual cell count from each coded Coulter sensor are shown in Table 1.

TABLE 1

| Coded sensor | Code | Cell count |
|---|---|---|
| Code 1, 1 | 1010111011000111110011010010000 | c₁₁ |
| Code 1, 2 | 0001101111011010001111110100000 | c₁₂ |
| Code 1, 3 | 0111001011010000110100110011110 | c₁₃ |
| Code 2, 1 | 1011010100011101111100100110000 | c₂₁ |
| Code 2, 2 | 0100110010111001110110011101000 | c₂₂ |
| Code 2, 3 | 1001010001000000011111011111101 | c₂₃ |

Further description of the electrodes and multiplex operation is provided in U.S. Pat. No. 12,370,548B2, which is incorporated by reference herein.

### Example Method of Fabrication

FIGS. 3 and 4 each show an example method of fabricating a scalable, low-cost polymer-made microfluidic device (e.g., 100, 200a, 200b, 200c, 200d) in accordance with an illustrative embodiment.

FIGS. 3A and 3B show the fabrication process and modular assembly of the thermoplastic microfluidic device. In FIG. 3A, a metal layer 108 that forms an electrode 106, a tracing 130, and electrode pads 128, 132 are formed on a polycarbonate substrate 102 using a solvent-minimized lithographic process. A metal stack 108 may be deposited (302), followed by photoresist patterning (304) and wet etching (306) to define the electrode structures. After pattern definition, flood exposure (308) is used to remove (310) the masking photoresist while minimizing solvent exposure to the thermoplastic substrate.

To form electrode 106, prior to metallization (304), polycarbonate substrates may be cleaned (e.g., by sequential rinsing with isopropanol and deionized water, followed by nitrogen drying). A thin metal stack (e.g., consisting of titanium and gold, or other metal or alloys described herein) may then be deposited (302) using electron-beam evaporation at controlled substrate temperature to mitigate stress arising from the thermal expansion mismatch between metal films and the thermoplastic substrate. An intermediate metal (e.g., titanium (10 nm)) may be employed as the adhesion layer, while a metal (e.g., gold (100 nm)) is employed to form the conductive electrode surface.

Following metal deposition (302), a positive photoresist (303) may be spin-coated to achieve a resist thickness (e.g., 1 μm-10 μm). The resist (303) may be soft-baked and patterned using a mask aligner with a broadband UV exposure dose. After exposure, the resist (303) may be developed in a developer and rinsed with deionized water to reveal the patterned metal regions (304).

The exposed metal stack may be subsequently removed using sequential wet chemical etching (306). The process defines the final electrode structures 106 on the thermoplastic substrate 102. The electrodes 106 may have a feature size that is less than 10 μm, e.g., less than 5 μm, less than 4 μm, less than 3 μm, less than 2 μm, less than 1 μm. To provide a reliable pattern on the photoresist, the opening defined between the photoresist as the minimum feature size in the structure would have a photoresist thickness similar to the structure. For example, a 1 micron feature size would entail providing a 1 micron thick photoresist.

After pattern definition, the remaining photoresist may be removed (e.g., 308) using UV flood exposure (312) through the transparent thermoplastic substrate, which weakens the photoresist adhesion and enables resist removal without aggressive solvent stripping or prolonged plasma treatment using the resist developer. By not using solvents or oxygen plasma treatments, deformation, swelling, or metal delamination issues can be avoided.

Although polycarbonate was used in the present device, the fabrication strategy is broadly compatible with a range of common thermoplastic materials used in microfluidic devices, including cyclic olefin copolymer (COC), cyclic olefin polymer (COP), polystyrene (PS), and polymethyl methacrylate (PMMA). These materials share similar chemical resistance and thermal properties that enable metal deposition, photolithographic patterning, and wet etching without significant substrate degradation. As a result, the described process provides a general route for integrating lithographically defined electrodes onto a wide range of polymer-based microfluidic platforms.

FIG. 3B shows an example method 330 of fabricating thermoplastic microfluidic layers using hot embossing. In FIG. 3B, a silicon master mold 340 containing the microfluidic structures is first fabricated (334) using deep reactive ion etching (DRIE). Polydimethylsiloxane (342) may be cast onto the silicon mold (340) to form a flexible stamp, which may then be used to emboss (338) microfluidic channel features into polycarbonate substrates (344).

FIG. 3C shows a modular device assembly 346. The electrode layer fabricated per the method described in relation to FIG. 3A and the microfluidic channel layer fabricated per the method described in relation to FIG. 3B may be bonded, e.g., using heat-assisted solvent bonding optimized to preserve electrode integrity and channel geometry. The capture chamber layer containing micropillar structures for cell capture may be bonded to the channel layer using a pressure-sensitive adhesive (PSA) to avoid exposure of antibody-functionalized surfaces to solvents or elevated temperatures. FIG. 3D shows the final assembled device integrating electrical sensing electrodes (346) with a microfluidic capture chamber (344).

Electrode Fabrication on Thermoplastics. FIGS. 4A and 4B show a method 400 to lithographically define electrodes directly on embossed thermoplastic structures, allowing the realization of opposing electrode configurations required for uniform electric-field sensing. In FIG. 4A, electrodes were fabricated directly on the plastic layers using a solvent-minimized lithographic process, e.g., as described in relation to FIG. 3A. A thin metal stack may first be deposited at a controlled temperature to mitigate stress caused by the thermal expansion mismatch between metal films and thermoplastic substrates. Photoresist may then be spin-coated and patterned using standard photolithography, followed by wet etching of titanium and gold to define electrode structures. After pattern definition, flood exposure may be used to remove the masking photoresist.

FIG. 4B shows an example fabrication (402) of thermoplastic microfluidic layers. The microfluidic channel layer (404) and capture chamber layer (406) may be fabricated from polycarbonate using a hot embossing process.

A silicon master mold 408 containing the microfluidic features may be first fabricated (410) using deep reactive ion etching (DRIE). Polydimethylsiloxane 412 may then be cast onto the silicon mold (408) and cured to produce a flexible PDMS replica of the microstructures.

The cured PDMS structure (412) may be subsequently used (414) as a stamp to emboss the microfluidic features into polycarbonate substrates (102). During embossing, the polycarbonate sheet may be heated above its glass transition temperature and pressed against the PDMS stamp under controlled pressure to transfer the microstructures. After cooling, the stamp may be separated from the thermoplastic substrate, leaving replicated microfluidic features in the polycarbonate layer (FIG. 6A, subpanel B).

Both the microfluidic channel layer and the capture chamber layer may be fabricated using this embossing approach, enabling reproducible replication of microstructures while maintaining compatibility with scalable thermoplastic manufacturing techniques.

### Example Plastic-Based Microfluidic Biochip for Immunoassay

### Example Device #1

FIG. 5A shows an example microfluidic device 500 configured to perform immunophenotyping on biological cells with surface markers. FIG. 5A, subpanel A shows an arrangement of the inlet/outlet (109a, 109b), feed/egress channels, sensing electrodes 106, and contact pads (128, 132), and capture microchamber 118 in the exemplary device. FIG. 5A, subpanel B shows a longitudinal cross-section of a fluidic path leading cells through the exemplary device. FIG. 5A, subpanel C shows the components of the exemplary device: (i) the feed/egress channel dimensions, (ii) the capture biomolecule-bearing micropillars, and (iii) the sensing electrodes placed on the floor of feed/egress channels. All dimensions of each component are cell-type specific and can be modified when a different species of cells are processed by the exemplary device.

While the electrodes are shown in FIG. 5A, subpanel A in proximity to the device inlet or outlet, it is contemplated that the arrangement in the exemplary device in FIG. 5A, subpanel A can be implemented as a single unit of an article of manufacture that can be replicated, i.e. a single device can have many microchambers each with their own feed and egress vias.

In FIG. 5A, the exemplary device can receive biological cells at its inlet 109a and lead them via pneumatic, flow-based, or capillary action-based means (e.g., a fluidic path). When the cells flow through a sensing region of embedded electrodes 106a (e.g., Coulter-counter-type) in the fluidic path, their features (e.g., electrical, mechanical, physical, etc.) can be measured. These cells can then flow to a microchamber 118, where they can be immobilized based on their attributes (e.g., surface markers, size, etc.). Cells that are not immobilized in the microchamber 118 pass through an uninhibited end exit, at which point they are (i) first polled by another set of sensing electrodes 106b before being presented to another capture microchamber or (ii) reaching the device exit where they are exhausted. Further, the microchambers 118 can be arranged in series, in parallel, or both. In some embodiments, a cell that leaves a microchamber can either go into a subsequent microchamber or reach the device exit i.e. the outlet. The electrode placement can be placed in relation to a microchamber.

The exemplary device can rely on (a) a biochemical functionalization process that immobilizes capture molecules (such as antibodies, aptamers, etc.) in the capture regions, (b) a fabrication process that facilitates deposition of sensing electrodes, (c) microchambers that contain capture biomolecule-bearing micropillars, and (d) material selection that provides all necessary components (e.g., sensing electrodes, capture biomolecules, connecting fluidic channels etc.) to be assembled in a manner compatible with the fabrication process.

Functionalization. To capture target cells from a heterogeneous population that includes non-target cells mixed in, the microchamber (e.g., 118) employs tightly packed micropillars (e.g., 120) with an edge-to-edge pitch of no more than 1.5× the expected average cell diameter to ensure physical interaction. The micropillars (e.g., 120) can be staggered such that no streamline exists where cells that enter the microchamber can pass through this microchamber without coming into contact with a micropillar. The micropillars can be biochemically functionalized to feature one or more capture molecules (e.g., antibody, aptamer) by being coated with appropriate compounds to bind with corresponding complementary compounds on the capture biomolecules. For example, (a) an avidin coating on the micropillars to bind with biotinylated antibody, (b) thiol or cyclooctyne coating on the micropillars to bind with azide-linked antibody, (c) polydopamine/Protein G coating on the micropillars to bind with the antibody Fc region, or (d) azide linking on the micropillars to bind with aptamers that target any number of relevant surface biomarkers on the target cells.

Example Device #2. FIGS. 5B and 5C each show an example modular plastic microfluidic biochip designed for electrical immunophenotyping of cells based on differential cell counting. In FIGS. 5B and 5C, the device is shown with three layers and includes an electrode substrate (Layer 1), a microfluidic flow layer (Layer 2), and a capture chamber (e.g., 118) containing antibody-functionalized micropillars (Layer 3). Cells entering the device 500 are first detected by embedded sensing electrodes 106 using an impedance-based counting approach derived from CODES technology. Within the capture chamber, target cells expressing specific surface markers are selectively immobilized by antibody-functionalized micropillars, while non-target cells continue to flow through the device. A second set of sensing electrodes located downstream of the capture region detects the remaining cells, enabling the number of captured cells to be determined through differential counting between upstream and downstream measurements.

The operating principle of the device is illustrated in FIG. 1c, where cells are first counted at the inlet electrode (Nin), followed by selective capture of antigen-positive cells within the functionalized chamber. Cells that are not captured exit the chamber and are detected at the downstream electrode (Nout). The number of captured cells is therefore determined as N_{captured}=Nᵢₙ−Nₒᵤₜ. The differential counting strategy enables electrical immunophenotyping without requiring fluorescent labeling or complex optical instrumentation.

### Example Modular and Parallelizable Microfluidic Devices and Configurations

Beyond the implementation of a single capture chamber, the multi-layer polymer microfluidic device (e.g., 100) may be designed with a modular microfluidic framework in which functional components can be independently fabricated and assembled in configurable sequences. The modular configuration can provide different microfluidic operations, for example, and not limited to, sample conditioning, flow manipulation, cell processing, biochemical interaction, sensing, and output handling, among others, which can be combined in any order or sequence to construct application-specific workflows. Each module can perform a specified function within a standardized fluidic flow modularized by standardized fluidic interfaces, to allow individual blocks to be added, removed, or rearranged without redesigning the entire device.

The modular multi-layer polymer microfluidic device can also employ the integration of multiple sensing modalities and processing operations within a single platform. For example, upstream modules may perform sample conditioning tasks such as dilution, reagent addition, or buffer exchange, while downstream modules can implement flow manipulation strategies including hydrodynamic focusing, serpentine mixing, or flow resistance control. Additional modules can implement cell processing operations such as size-based filtration, deterministic lateral displacement (DLD) separation, magnetic enrichment, or cell pairing. These processing blocks can then be followed by biochemical interaction chambers—such as antibody-functionalized capture chambers, incubation chambers, or mechanical trap arrays—enabling targeted interrogation of cellular phenotypes.

FIGS. 5D and 5E show an example programmable modular microfluidic platform for configurable cell analysis workflows, as well as example workflows for cell processing and analysis. FIG. 5D shows an example library of interchangeable microfluidic modules categorized by function, including sample conditioning, flow manipulation, cell processing, biochemical interaction, measurement, and control. Each module is represented as a standardized building block that can be assembled in arbitrary sequences to construct customized workflows.

FIG. 5E shows an example representative implementations of the modular platform. For cell immunophenotyping workflow (see “I”), cells are labeled and washed, followed by upstream electrical measurement to determine the initial cell count (Nᵢₙ), immunocapture within a functionalized chamber, and downstream electrical measurement to determine the remaining cell count (N_out), enabling quantification of captured cells (N_{captured}=Nᵢₙ−Nₒᵤₜ). For the negative enrichment workflow (see “II”), after labeling and washing, cells undergo inlet counting, immunocapture, and outlet counting, followed by valve-controlled routing and downstream mechanical capture for further enrichment or analysis. This modular architecture enables flexible integration of physical, biochemical, and electrical operations within a single reconfigurable microfluidic system.

A benefit of the modular platform is the ability to construct parallel microfluidic architectures in which the incoming sample stream is distributed across multiple branches containing different processing or capture modules. In this configuration, the same sample population can be simultaneously analyzed under multiple conditions or against multiple biochemical targets. For instance, separate branches can contain capture chambers functionalized with different antibodies or affinity ligands targeting distinct surface markers. This parallel configuration enables multiplexed phenotyping, where different cellular subpopulations are selectively captured and quantified within dedicated branches of the device.

### Multiplexed Cell Processing and Phenotyping.

FIG. 5F shows serial and parallel assembly of modular microfluidic units enabling multiplexed cell processing and phenotyping. Standardized microfluidic modules containing integrated sensing electrodes and functional interaction chambers can be combined to construct configurable workflows. Each module includes a microfluidic chamber positioned between upstream and downstream sensing electrodes, enabling differential electrical counting of cells before and after interaction regions. Modules can be assembled sequentially to perform multiple processing steps within a single flow path, or arranged in parallel architectures in which the incoming sample is distributed across multiple branches. In parallel configurations, each branch may contain distinct capture chambers or cell-processing modules that target different cellular phenotypes or perform different assay functions. Interaction chambers may operate through biochemical affinity capture, such as antibody-functionalized micropillar arrays, or through mechanical trapping structures that physically immobilize cells within microfabricated traps. This architecture enables scalable multiplex analysis, where multiple cell populations or experimental conditions can be interrogated simultaneously within a single platform.

Within each branch, the platform maintains the same differential electrical counting principle used in the single-chamber implementation. Cells entering a branch are first detected by an upstream impedance sensing electrode (N_{in,i}), followed by passage through a phenotype-specific capture chamber. Cells that are not captured continue downstream and are detected by a second electrode (N_{out,i}). The number of cells captured in branch i can therefore be determined per Equation 1.

N_{captured,i}=N_{in,i}−N_{out,i} (Eq. 1)

By implementing multiple parallel branches, the device can generate a multiparametric phenotypic profile of the sample population, where each branch corresponds to a distinct biochemical interaction or cell-processing pathway. Because each module is independently configurable, the same platform can be adapted for different assays by simply rearranging or replacing functional blocks rather than redesigning the entire microfluidic device. The modular and parallelizable architecture transforms the device from a single-purpose microfluidic assay into a programmable microfluidic platform capable of multiplexed cell analysis, phenotype-specific capture, and integrated electrical sensing. The approach enables flexible workflow construction while maintaining compatibility with thermoplastic fabrication methods suitable for scalable manufacturing.

### Multiplex Sensing Operation.

FIG. 5G shows an example of electrical acquisition of cell capture via a multiplex operation across the antibody microarray. In FIG. 5G, the system is configured for the sample delivery and electrical measurements. Cells 502 may be driven through the device at a constant flow rate with a syringe pump 504. An electrical sensor network 106 may be excited using a sine wave 505 generated from the lock-in amplifier 506, and the resulting current signals 508A-B may be first converted to voltage signals 510A-B using transimpedance amplifiers 512, then subtracted from each other by a differential amplifier 514, and the signal amplitude 516 is measured using a lock-in amplifier 506. The decoding process may then identify individual sensor signals in the device output signal 516. The output signal 516 may be correlated 518 with a template library 520 consisting of signature waveforms, such as 522A, corresponding to each and every coded sensor in the network using a decoder operation 518. A correlation peak 524 may be used to identify the matching template and the specific sensor that detected the cell. The specific case in the figure demonstrates the decoding of a signal produced by the sensor with the Code 2,3.

During an exemplary assay, the sample may be driven through the functionalized device by a syringe pump 504 at a controlled flow rate. The electrical signal 516 from the device may be acquired via electronic hardware and analyzed using a computer 526. To determine a capture location for each cell processed on the device, the output signal 516 may be processed by a decoding operation 518. The decoding operation may first review a part of the recorded electrical waveform, identify different code signals present, and classify them into different sensor groups. Once each sensor group contains a sufficient number of code signal instances, signals may be normalized and averaged to form a library of code templates that correspond to each and every sensor in the network. The generation of templates based on recorded signals from the sample itself made the templates specific to both the sample and the device, thereby increasing accuracy. The templates may then be used to process all sensor data by correlating the output signal with the template library. Because the code signals were specifically designed to be mutually orthogonal, the sensor signal can be classified robustly with minimal crosstalk and also resolve signal interferences through an iterative process called successive interference cancellation. At the end of this decoding process, the original output waveform may be decomposed into data from individual sensors, which may then be used to calculate cell capture statistics across the whole device. Specifically, the number of captured cells in each chamber may be obtained, by subtracting the exit node cell count from the entry node cell count.

### Example Device Fabrication and Assembly

### Example #1—Method of Fabrication

FIG. 6A shows an example device fabrication and assembly for a modular microfluidic device consisting of three functional layers: an electrode substrate (Layer 1), a microfluidic channel layer (Layer 2), and a capture chamber containing micropillar structures (Layer 3). Each layer may be fabricated independently using processes optimized for thermoplastic materials and subsequently assembled to form the final device.

Specifically, FIG. 6A subpanels A-C show the fabrication process and modular assembly of the thermoplastic microfluidic device. FIG. 6A subpanel A shows the fabrication (602) of gold electrodes on polycarbonate substrates using a solvent-minimized lithographic process. A titanium-gold metal stack (or other alloys or metals described herein) may be deposited (604), followed by photoresist patterning (606) and wet etching (608) to define the electrode structures. After pattern definition, flood exposure (610) may be used to remove (612) the masking photoresist while minimizing solvent exposure to the thermoplastic substrate.

FIG. 6A subpanel B (614) shows the fabrication of thermoplastic microfluidic layers using hot embossing. A silicon master mold containing the microfluidic structures is first fabricated (616) using deep reactive ion etching (DRIE) (618). Polydimethylsiloxane (PDMS, Sylgard 184) may be cast onto the silicon mold to form a flexible stamp (620), which may then be used to emboss (622, 624) microfluidic channel features into polycarbonate substrates.

FIG. 6A subpanel C (626) shows a modular device assembly. The electrode layer (Layer 1) and microfluidic channel layer (Layer 2) may be bonded using heat-assisted solvent bonding optimized to preserve electrode integrity and channel geometry. The capture chamber layer (Layer 3), containing micropillar structures for cell capture, may be bonded to the channel layer using a pressure-sensitive adhesive (PSA) to avoid exposure of antibody-functionalized surfaces to solvents or elevated temperatures. The final assembled device may integrate electrical sensing electrodes with a microfluidic capture chamber.

### Example Electrode Fabrication

Electrodes were fabricated directly on polycarbonate substrates using a solvent-minimized photolithographic process (FIG. 6A, subpanel A). Prior to metallization, polycarbonate substrates may be cleaned by sequential rinsing with isopropanol and deionized water, followed by nitrogen drying. A thin metal stack consisting of titanium and gold may then be deposited using electron-beam evaporation at controlled substrate temperature to mitigate stress arising from the thermal expansion mismatch between metal films and the thermoplastic substrate. Titanium (10 nm) served as the adhesion layer, while gold (100 nm) formed the conductive electrode surface.

Following metal deposition, a positive photoresist (S1813, MicroChem) may be spin-coated at 4000 rpm for 40 s to achieve a resist thickness of approximately 1.3 μm. The resist may be soft-baked at 100 °C for 60 s and patterned using a mask aligner (MLA150, Heidelberg Instruments) with a broadband UV exposure dose of approximately 100 mJ cm⁻². After exposure, the resist may be developed in MF-319 developer for 60 s and rinsed with deionized water to reveal the patterned metal regions.

The exposed metal stack may be subsequently removed using sequential wet chemical etching. Gold may be etched using a potassium iodide-iodine (KI/I₂) gold etchant, followed by removal of the titanium adhesion layer using a dilute hydrofluoric acid-based titanium etchant. This process defined the final electrode structures on the thermoplastic substrate.

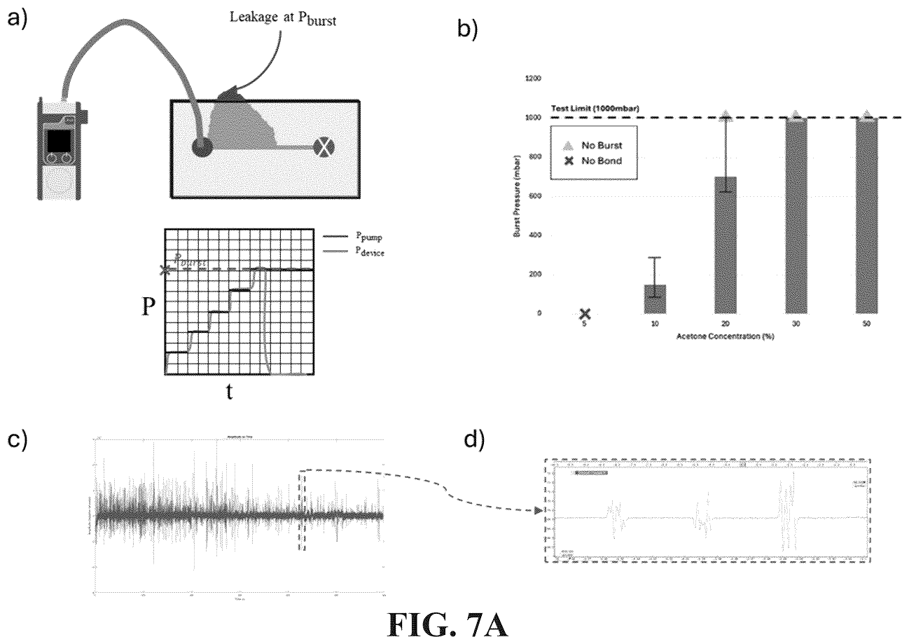

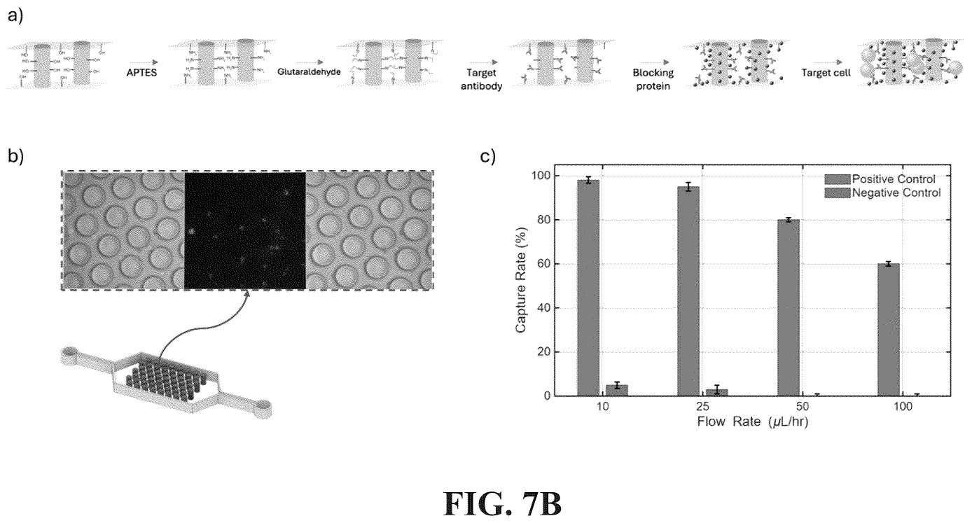

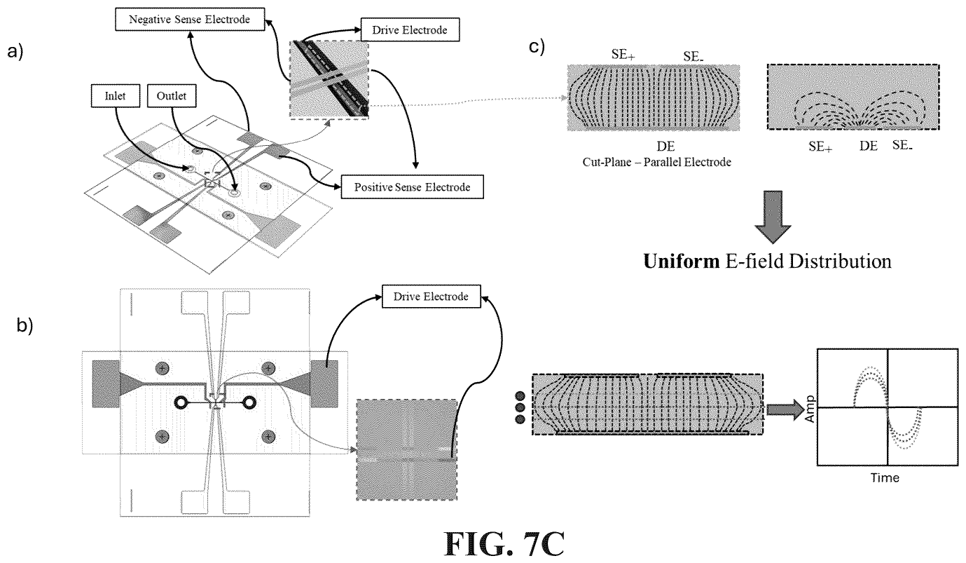

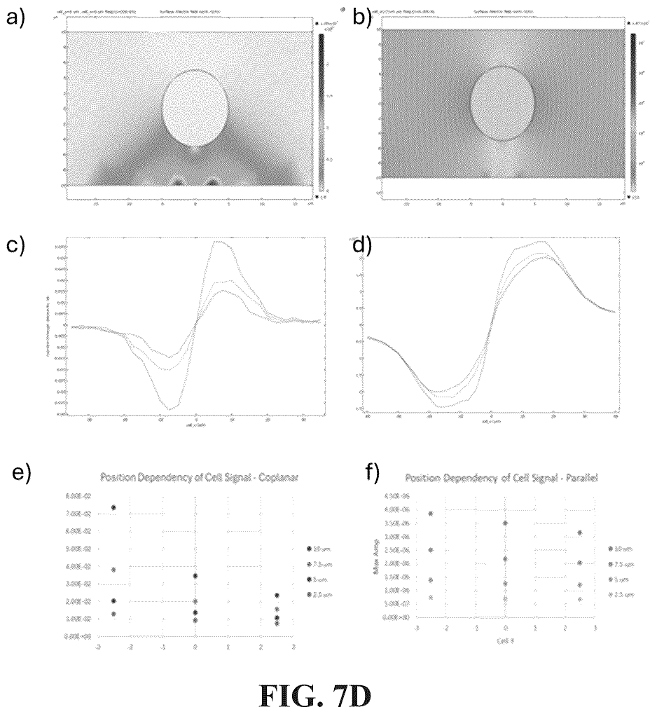

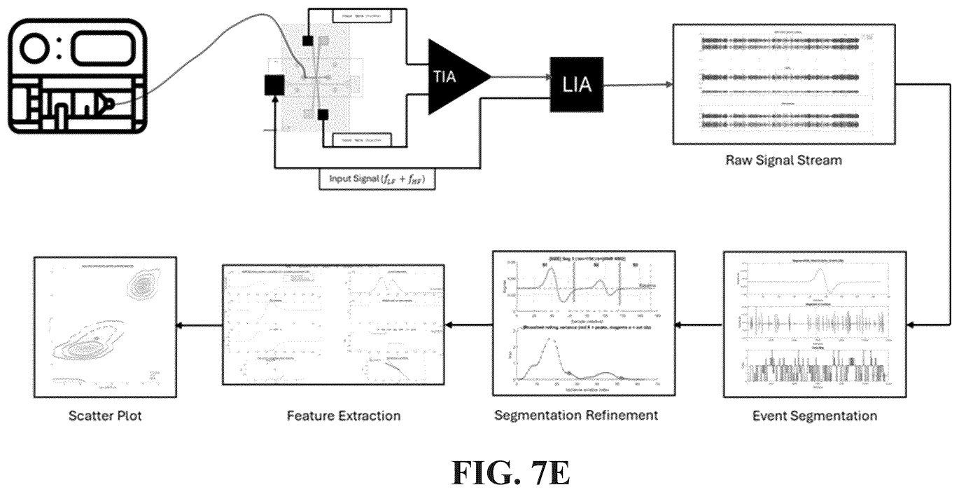

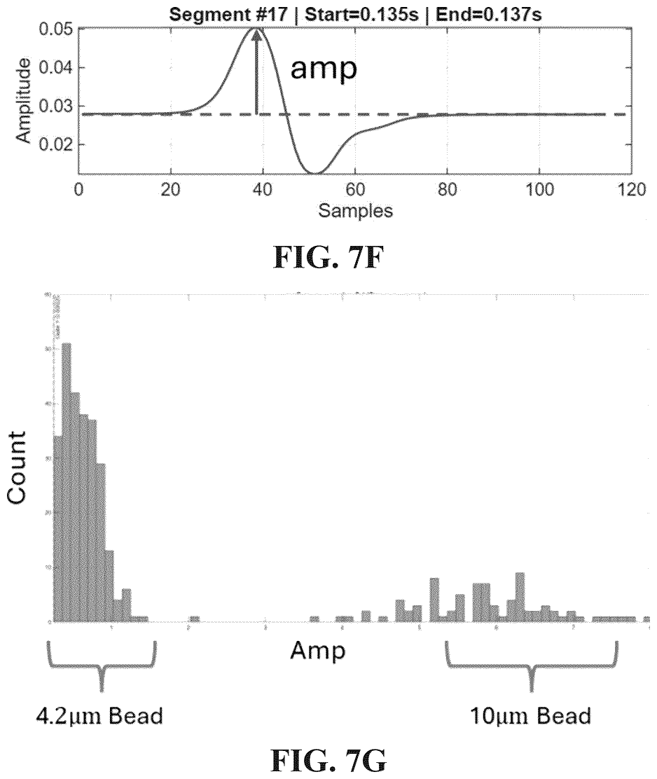

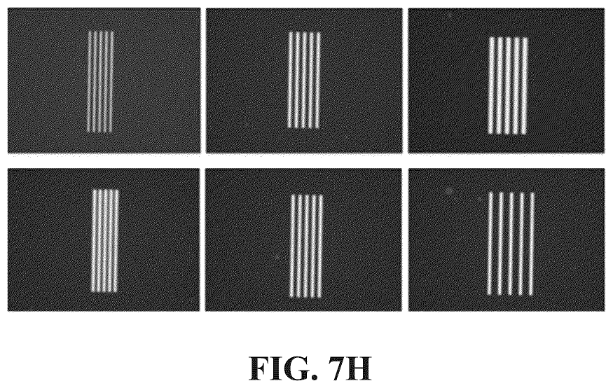

FIG. 7H shows an optical micrograph of interdigitated electrodes fabricated on polycarbonate substrates with varying feature dimensions. The first row shows electrodes with finger widths of 3 μm, 5 μm, and 10 μm (left to right), while the second row shows electrodes with corresponding gap spacings of 3 μm, 5 μm, and 10 μm. These images demonstrate reliable photolithographic patterning of interdigitated gold electrodes on thermoplastic substrates with feature sizes down to 3 μm, confirming the capability of the solvent-minimized lithographic process to produce high-resolution electrode structures on polymer-based microfluidic devices.

Using this lithographic process, electrode features with approximately 3 μm resolution were reproducibly fabricated on polycarbonate substrates. Representative microscope images of fabricated interdigitated electrodes with varying finger widths and gaps are shown in FIG. 6A, subpanel A, demonstrating reliable fabrication of electrode fingers and spacings down to 3 μm. In the present device, electrodes were implemented following the CODES sensing architecture, consisting of interdigitated electrode fingers with 5 μm width and 5 μm spacing, which were selected to balance electrical sensitivity, fabrication reliability, and device yield.

After pattern definition (e.g., 610), the remaining photoresist may be removed (e.g., 610) using UV flood exposure through the transparent thermoplastic substrate, which weakens the photoresist adhesion and enables resist removal without aggressive solvent stripping or prolonged plasma treatment using the resist developer (MF-319 in the case of our photoresist). Avoiding strong solvents or oxygen plasma treatments is important for thermoplastic substrates, as these processes can cause deformation, swelling, or metal delamination. The solvent-minimized lithographic approach, therefore, preserves substrate integrity while maintaining lithographic accuracy.

Although polycarbonate may be used in the present device, the fabrication strategy is broadly compatible with a range of common thermoplastic materials used in microfluidic devices, including cyclic olefin copolymer (COC), cyclic olefin polymer (COP), polystyrene (PS), and polymethyl methacrylate (PMMA). These materials share similar chemical resistance and thermal properties that enable metal deposition, photolithographic patterning, and wet etching without significant substrate degradation. As a result, the described process provides a general route for integrating lithographically defined electrodes onto a wide range of polymer-based microfluidic platforms.

While the current implementation reliably produces features down to approximately 3 μm, the resolution is primarily limited by photolithographic constraints and wet-etch undercut of the metal layers rather than the thermoplastic substrate itself. With optimized resist stacks, thinner metal films, or dry etching approaches, submicron electrode features could potentially be achieved on thermoplastic substrates using the same general fabrication strategy.

### Fabrication of Thermoplastic Microfluidic Layers.

FIG. 6A, subpanel B shows an example fabrication (632) of thermoplastic microfluidic layers. The microfluidic channel layer (Layer 2) and capture chamber layer (Layer 3) may be fabricated from polycarbonate using a hot embossing process.

A silicon master mold containing the microfluidic features may be first fabricated (634) using deep reactive ion etching (DRIE). Polydimethylsiloxane (PDMS, Sylgard 184) may then be cast onto the silicon mold using a 10:1 base-to-curing-agent ratio and cured at 72 °C for 4 hours to produce a flexible PDMS replica of the microstructures.

The cured PDMS structure may be subsequently used (640) as a stamp to emboss (642) the microfluidic features into polycarbonate substrates. During embossing, the polycarbonate sheet may be heated above its glass transition temperature and pressed against the PDMS stamp under controlled pressure to transfer the microstructures. After cooling, the stamp may be separated from the thermoplastic substrate, leaving replicated microfluidic features in the polycarbonate layer (FIG. 6A, subpanel B).

Both the microfluidic channel layer and the capture chamber layer may be fabricated using this embossing approach, enabling reproducible replication of microstructures while maintaining compatibility with scalable thermoplastic manufacturing techniques.

### Device Assembly and Bonding.

Following fabrication of the individual layers, the device may be assembled (626) using a combination of heat-assisted solvent bonding and pressure-sensitive adhesive (PSA) bonding, as illustrated in FIG. 6A, subpanel C.

Layer 1 (electrode substrate) and Layer 2 (microfluidic channel layer) may be bonded (628) using a heat-assisted solvent bonding process optimized to preserve the integrity of both the metal electrodes and the embossed microfluidic structures. Prior to bonding, the two layers may be carefully aligned and temporarily constrained using tacky tape to maintain positional accuracy. A PDMS pressure distribution layer may then be placed on top of the stacked substrates to ensure uniform pressure during the bonding process.

The PDMS layer may contain ventilation holes connected to an absorbent pad, allowing excess solvent to escape during bonding. When the assembly may be placed under controlled heat and pressure, the absorbent pad may help remove evaporating solvent while the PDMS layer distributes the applied pressure evenly across the device surface. The setup may prevent solvent accumulation and minimize the risk of channel deformation or electrode delamination during the bonding process.

Layer 2 (channel layer) and Layer 3 (capture chamber layer) were bonded (629) using a pressure-sensitive adhesive (PSA) layer. The bonding operation avoids exposing the antibody-functionalized surfaces within the capture chamber to solvents or elevated temperatures that could compromise the biochemical functionality of the device.

This hybrid bonding strategy enables robust mechanical integration of the modular layers while maintaining compatibility with both electrical sensing elements and surface-functionalized capture structures.

### Example #2—Method of Fabrication

FIG. 6B shows the device architecture and fabrication process of the parallel-electrode thermoplastic microfluidic sensor. Specifically, FIG. 6B, subpanel A shows a schematic illustration of the multilayer device architecture consisting of four thermoplastic layers: a fluidic interface layer, particle filtering layer, measurement channel layer with integrated reference electrode, and opposing sensing electrode layer. The reference electrode may be patterned on the same substrate that defines the microfluidic channel to ensure accurate alignment with the sensing region. FIG. 6B, subpanel B, shows a fabrication workflow for microfluidic structures. Silicon masters may be fabricated using DRIE and KOH micromachining and used to replicate PDMS intermediate molds. These molds may then be used to hot-emboss microfluidic structures into polycarbonate substrates. A Ti/Au metal stack may be deposited and patterned using photolithography and wet etching to form lithographically defined electrodes on the plastic surface. Flood exposure may be used to remove photoresist without aggressive solvent stripping. Individual thermoplastic layers may be aligned and bonded using controlled heat and limited solvent exposure to form a sealed microfluidic device with opposing electrodes positioned across a 20-μm-high sensing channel.

### Device Architecture and Fabrication.

The device consists of four stacked thermoplastic layers: a Fluidic Interface Layer, a Particle Filtering Layer, a Measurement Channel Layer with an integrated reference electrode, and an Opposing Electrode Layer, as illustrated in FIG. 6B. The reference electrode may be patterned on the same substrate that defines the microfluidic channel, ensuring alignment between the channel geometry and the sensing electrodes.

Opposing electrodes may be positioned across a 20-μm-high microfluidic channel, forming a parallel-plate sensing region. The electrode width used in this work is 20 μm, matching the channel height; however, the fabrication method supports electrode dimensions down to approximately 3 μm resolution, enabling flexible scaling of sensing geometry when required.

This configuration forms the parallel-electrode sensing architecture introduced conceptually in FIG. 1, enabling a more uniform electric field distribution across the sensing region than conventional coplanar electrode arrangements.

### Microfluidic Structure Fabrication.

Microfluidic layers were fabricated in polycarbonate thermoplastic using hot embossing, a widely used manufacturing technique for disposable microfluidic cartridges due to its scalability and compatibility with polymer substrates.

Embossing molds were produced by replicating PDMS stamps from micromachined silicon masters fabricated using deep reactive ion etching (DRIE) and KOH anisotropic wet etching, as illustrated in FIG. 6B. The PDMS structures serve only as intermediate molds and are not part of the final device.

This replication strategy can enable high-resolution silicon microfabrication to be transferred into thermoplastic substrates, combining the precision of silicon processing with the manufacturability of polymer microfluidics. Similar approaches have been widely used to translate microfabricated features into thermoplastic devices for disposable lab-on-a-chip systems.

### Electrode Fabrication on Thermoplastics.

FIG. 6B shows a method to lithographically define electrodes directly on embossed thermoplastic structures, allowing the realization of opposing electrode configurations required for uniform electric-field sensing. In FIG. 6B, electrodes were fabricated directly on the plastic layers using a solvent-minimized lithographic process. A thin titanium-gold metal stack may be first deposited at a controlled temperature to mitigate stress caused by the thermal expansion mismatch between metal films and thermoplastic substrates. Photoresist may then be spin-coated and patterned using standard photolithography, followed by wet etching of titanium and gold to define electrode structures. After pattern definition, flood exposure may be used to remove the masking photoresist, avoiding aggressive solvent stripping or prolonged plasma treatment that can damage thermoplastic substrates. This solvent-minimized process can reduce the risk of polymer swelling, surface deformation, and metal delamination, which are commonly encountered when conventional lift-off or solvent-based stripping processes are applied to plastic microfluidic devices.

### Layer Alignment and Bonding.

FIG. 6B also shows an example of layer alignment and bonding. Following fabrication, individual layers were aligned and bonded to form the final stacked device. Bonding may be performed using controlled heat and limited solvent exposure, providing reliable sealing of embossed microfluidic channels while preserving electrode integrity and alignment. Thermally assisted bonding methods are commonly used in thermoplastic microfluidic systems because they enable strong interlayer adhesion while maintaining compatibility with large-area polymer substrates. Accurate alignment of opposing electrodes across the 20-μm channel height can assist in producing a uniform electric field in the sensing region, and the fabrication method presented here enables this alignment in disposable thermoplastic devices.

### Fabrication Capabilities.

The fabrication approach demonstrated here enables (i) lithographically precise parallel electrodes directly on thermoplastics, (ii) integration of electrodes on embossed microfluidic channel surfaces, (iii) electrode dimensions scalable from tens of microns down to ~3 μm resolution, (iv) reliable multilayer bonding with minimal solvent exposure, and (v) compatibility with disposable plastic microfluidic cartridges. These capabilities enable practical implementation of uniform-field impedance sensors in plastic microfluidic systems while retaining the flexibility and scalability of lithographic electrode design.

### Experimental Results and Additional Examples

A study was conducted to develop and evaluate a modular plastic microfluidic platform designed for electrical immunophenotyping of cells based on differential cell counting. The device consisted of a three-layer architecture composed of an electrode substrate (Layer 1), a microfluidic flow layer (Layer 2), and a capture chamber containing antibody-functionalized micropillars (Layer 3) (see, e.g., FIG. 5B and FIG. 5C). Cells entering the device are first detected by embedded sensing electrodes using an impedance-based counting approach derived from CODES technology. Within the capture chamber, target cells expressing specific surface markers are selectively immobilized by antibody-functionalized micropillars, while non-target cells continue to flow through the device. A second set of sensing electrodes located downstream of the capture region detects the remaining cells, enabling the number of captured cells to be determined through differential counting between upstream and downstream measurements.

### Bonding Integrity and Electrical Characterization.

FIG. 7A, subpanels A-D shows assessment and results for bonding integrity and electrical characterization of the modular microfluidic device. Specifically, FIG. 7A, subpanel A shows the experimental setup used for burst pressure testing. To evaluate the mechanical robustness of the bonded thermoplastic device, burst pressure experiments were performed using the setup. In this experiment, the outlet of the microfluidic device was sealed while the inlet was connected to a pressure pump. The applied pressure was gradually increased until leakage occurred, at which point the internal pressure dropped abruptly. The maximum pressure reached prior to failure was recorded as the burst pressure of the device. The device outlet is sealed while the inlet is connected to a pressure pump. The internal pressure is gradually increased until leakage occurs, resulting in a sudden pressure drop that defines the burst pressure of the bonded device.

FIG. 7A, subpanel B shows burst pressure as a function of acetone concentration used during solvent bonding. Increasing solvent activation significantly improves bonding strength. Devices fabricated with 20-50% acetone withstand pressures approaching the experimental test limit (~1000 mbar), while low solvent concentration results in weak bonding. A concentration of 30% acetone in IPA was selected as the optimal bonding condition due to its high bonding strength and minimal dimensional distortion of the thermoplastic microstructures. FIG. 7A, subpanel C, shows a representative raw impedance signal trace acquired from the sensing region during particle transit. The signal exhibits a stable baseline with transient perturbations corresponding to particles passing across the electrode array. FIG. 7A, subpanel D shows magnified segment of the signal showing distinct signatures generated by the CODES electrode architecture, where sequential perturbations of the electric field produce characteristic signal patterns that can be decoded to identify individual particle events

The influence of solvent activation on bonding strength was investigated by varying the acetone concentration used during the solvent bonding process. As shown in FIG. 7A, subpanel B, the burst pressure increased significantly with increasing acetone concentration, indicating improved bonding strength due to enhanced surface activation. Devices prepared with low solvent concentration (5%) showed poor bonding and failed to form a sealed interface. Increasing the acetone concentration improved the bonding performance, with devices fabricated using 20-50% acetone capable of withstanding pressures approaching 1000 mbar, which corresponds to the upper test limit of the experimental setup.

Although higher acetone concentrations produced strong bonding, excessive solvent exposure can induce dimensional distortion in thermoplastic microstructures. Therefore, 30% v/v acetone in IPA was selected as the optimal bonding condition, providing high bonding strength while maintaining structural integrity of the microfluidic channels.

To evaluate the electrical sensing capability of the device, impedance signals were acquired while particles passed through the sensing region. A representative raw signal trace is shown in FIG. 7A, subpanel C, demonstrating stable baseline behavior with distinct transient signals corresponding to particle transits across the electrode sensing region.

A magnified section of the signal is presented in FIG. 7A, subpanel D, where individual signal signatures corresponding to different CODES electrode patterns can be observed. These characteristic signal patterns arise from the sequential perturbation of the electric field as particles traverse the interdigitated electrode array and form the basis for decoding particle events within the sensing region.

### Functionalization and Capture Performance.

FIG. 7B shows surface functionalization and capture performance of the microfluidic capture chamber. FIG. 7B, subpanel A shows a schematic illustration of the surface functionalization workflow used to immobilize capture antibodies on the polycarbonate micropillar structures. Following plasma activation of the polycarbonate surface, (3-aminopropyl)triethoxysilane (APTES) is applied to introduce amine groups. Glutaraldehyde is subsequently used as a crosslinker to enable covalent immobilization of target antibodies. A blocking step using bovine serum albumin (BSA) is then performed to suppress non-specific adsorption prior to target cell capture.

FIG. 7B, subpanel B, shows representative microscopy images of the capture chamber showing fluorescently labeled target cells captured on antibody-functionalized micropillars. The middle image shows fluorescence imaging of captured cells, while the surrounding brightfield images illustrate the micropillar structures within the capture region. Cells used in this experiment were heat-treated to induce Annexin V expression, enabling fluorescent labeling and visualization of the target population.

### Capture Efficiency.

FIG. 7B, subpanel C, shows the capture efficiency of target cells as a function of flow rate. Positive control cells show high capture efficiency at low flow rates, with capture rates approaching ~98% at 10 μL/hr and gradually decreasing with increasing flow due to reduced residence time and increased hydrodynamic forces. Negative control cells exhibit minimal capture across all tested flow conditions, confirming effective suppression of non-specific binding through the implemented surface functionalization and blocking strategy.

### Surface Functionalization and Cell Capture Characterization.

To enable selective capture of target cells within the microfluidic capture chamber, the polycarbonate capture layer was chemically functionalized using an open-top surface modification approach, which provides improved scalability compared to closed-channel functionalization methods. The functionalization workflow is illustrated in FIG. 7B, subpanel A.

Prior to chemical modification, the polycarbonate surface was activated using oxygen plasma treatment for 5 minutes, generating hydroxyl groups that facilitate subsequent silanization. The activated surfaces were then treated with (3-aminopropyl)triethoxysilane (APTES) to introduce amine functional groups on the substrate. Following silanization, glutaraldehyde was applied as a crosslinking agent to enable covalent immobilization of target antibodies on the capture structures. After antibody immobilization, a blocking step using bovine serum albumin (BSA) was performed to reduce non-specific adsorption of cells.

To further minimize non-specific binding, the pressure-sensitive adhesive (PSA) layer used during device assembly was also incubated in BSA prior to bonding. This additional blocking step reduces unintended interactions between cells and exposed adhesive surfaces within the microfluidic device.

Representative microscopy images of the capture structures after functionalization and cell capture are shown in FIG. 7B, subpanel B. The images display fluorescently labeled target cells captured on the micropillar structures within the capture chamber. In these experiments, cells were heat-treated to induce Annexin V expression, allowing fluorescent labeling and visualization of the target population. The fluorescence signal confirms selective localization of labeled cells on the antibody-functionalized capture structures.

### Capture Performance for Different Flow.

The capture performance of the device was further evaluated under different flow conditions. As shown in FIG. 7B, subpanel C, capture efficiency was measured as a function of flow rate for both positive control cells (expressing the target marker) and negative control cells. The results demonstrate high capture efficiency for the target cell population at low flow rates, with capture rates approaching ~98% at 10 μL/hr and ~95% at 25 μL/hr. As the flow rate increases, capture efficiency gradually decreases due to reduced residence time and increased hydrodynamic forces acting on the cells.

In contrast, the negative control population exhibited minimal capture across all tested flow conditions, indicating that non-specific binding was effectively suppressed by the surface functionalization and blocking strategy. These results confirm that the functionalized capture chamber enables selective enrichment of target cells while maintaining low background adhesion.

Fabrication of Plastic-Based Parallel-Electrode Impedance Sensors Enabling Uniform Electric Field Distribution Across Channel Depth. FIG. 7C subpanels A and B show position-dependent sensing in coplanar electrodes and improved uniform-field sensing using parallel electrodes. Specifically, FIG. 7C, subpanel A shows an overview of the multilayer microfluidic device showing the location of the sensing region within the stacked thermoplastic architecture.

FIG. 7C, subpanel B, shows an electric field distribution generated by opposing parallel electrodes across the microfluidic channel, illustrating a relatively uniform field across the sensing region. FIG. 7C, subpanel C shows an electric field distribution for a conventional coplanar electrode configuration, where the electric field is concentrated near electrode edges and decays rapidly away from the surface. FIG. 7C, subpanel D, shows an illustration of particle trajectories across the sensing channel, showing how position variation affects the local electric field experienced by particles. FIG. 7C, subpanel E, shows the resulting electrical signals produced by particles traveling at different vertical or lateral positions within the sensing region. In non-uniform coplanar fields, identical particles can produce significantly different signals depending on their trajectory, whereas the more uniform field produced by parallel electrodes reduces position-dependent variation and enables signals that correlate more directly with particle size and electrical properties.

### Field Non-Uniformity in Coplanar Electrodes.

Electrode configuration plays a fundamental role in the performance of impedance-based biological and chemical sensing systems. The spatial arrangement of electrodes determines the electric field distribution within the sensing volume, which in turn defines the sensitivity profile of the sensor. When a particle or cell enters the sensing region, it locally perturbs the complex permittivity of the medium. From first-order electromagnetic perturbation theory commonly used in dielectric spectroscopy and impedance cytometry, the resulting change in measured impedance can be expressed in Equation 2.

$$Δ Z ∝ {\int }_{V} ( {ϵ}_{p}^{*} - {ϵ}_{m}^{*} ) {\vert E ( r ) \vert}^{2} d V \qquad ( Eq . 2 )$$

In Equation 2, ΔZ is the impedance change, V is the particle volume, [symbol] are the complex permittivities of the particle and medium, and E (r) is the electric field distribution before perturbation. This expression shows that sensor sensitivity is proportional to the local electric-field energy density, explaining why electrode geometry directly affects measurement accuracy.

Because the impedance perturbation scales with the square of the local electric field magnitude, non-uniform electric fields lead directly to position-dependent measurements. In such cases, the measured signal reflects not only the intrinsic electrical properties of the sample but also its trajectory, height, and orientation within the channel. As a result, identical particles traversing different regions of the sensing volume can produce significantly different signals. Non-uniform fields can also introduce orientation-dependent responses for elongated particles or cells, further reducing quantitative accuracy.

Coplanar electrode geometries are widely used in microfluidic impedance sensors because they are straightforward to fabricate using planar lithography on silicon or glass substrates. However, numerical simulations and analytical studies have shown that coplanar configurations generate strongly non-uniform electric fields concentrated near electrode edges, leading to measurement errors that depend on particle trajectory within the sensing region. This effect becomes more pronounced as channel height increases, because particles occupy a wider range of vertical positions while the coplanar field decays rapidly away from the electrode surface.

The difference in electric field distribution between coplanar and parallel electrode configurations is illustrated in FIG. 7C. As shown in the figure, coplanar electrodes produce electric fields that are concentrated near the electrode edges and decay rapidly away from the surface. In contrast, parallel electrode configurations generate a more uniform electric field across the sensing region, reducing sensitivity to particle position within the channel.

### Need for Parallel Electrode Sensors on Plastic.

Parallel electrode configurations, therefore, provide a promising approach to reduce position-dependent sensing errors.

As shown in FIG. 7C, when a particle moves through a more uniform electric field, the perturbation of the field becomes more consistent, producing electrical signals that are more strongly related to particle size and dielectric properties rather than particle position. In plastic microfluidic devices, electrodes are often implemented using techniques such as screen printing, inkjet printing, shadow masking, or lamination of prefabricated conductive films. While these approaches enable low-cost fabrication, they typically produce relatively large electrode features and limited alignment precision. This limitation is particularly important for disposable plastic microfluidic cartridges, where coplanar electrodes are frequently used due to fabrication simplicity, despite their non-uniform sensing fields.

Several attempts have been made to fabricate parallel-electrode microfluidic sensors using laminated dry-film photoresist structures, embedded metal wires, or multilayer polymer assemblies. These approaches demonstrate proof-of-concept parallel electrode sensing but often suffer from limited sealing robustness, restricted lithographic precision, or alignment challenges. Disposable polymer-film impedance cytometers using parallel-facing electrodes fabricated from conductive films and adhesive layers have also been reported. Reviews of microfluidic impedance biosensors further highlight that electrode geometry and substrate choice strongly influence sensing performance and that achieving uniform field distributions in disposable plastic microfluidic platforms remains an ongoing challenge.

Consequently, despite prior demonstrations of parallel electrode sensing and polymer-based impedance devices, there remains a need for a fabrication method that enables lithographically precise parallel electrodes directly on solvent-sensitive plastic substrates while maintaining reliable sealing, accurate alignment, and compatibility with embossed microfluidic channel structures. Conventional lift-off processes rely on aggressive solvents that can swell or damage common microfluidic plastics, while shadow-mask or printing approaches limit feature resolution.

These challenges motivate the sensor architecture presented in this work, which enables lithographically defined parallel electrodes on plastic using a solvent-minimized fabrication approach. In particular, a method that enables lithographically accurate parallel electrodes on embossed plastic channels while minimizing solvent exposure would significantly improve measurement uniformity and enable robust microfluidic impedance sensing in disposable platforms.

FIG. 7D, subpanels A-F shows FEM simulation comparing coplanar and parallel electrode sensing geometries. Specifically, FIG. 7D, subpanel A shows an electric field distribution for the coplanar electrode configuration showing strong field concentration near electrode edges. FIG. 7D, subpanel B shows an electric field distribution for the parallel electrode configuration showing a more uniform field across the sensing region. FIG. 7D, subpanels C and D show simulated differential signal waveforms for particles traveling at different lateral positions in the channel for coplanar (FIG. 7D, subpanel C) and parallel (FIG. 7D, subpanels D) configurations. FIG. 7D, subpanels E and F show peak signal amplitude as a function of particle position for particles of different diameters (5 μm, 7.5 μm, and 10 μm) for coplanar (FIG. 7D, subpanel E) and parallel (FIG. 7D, subpanel F) electrode geometries.

### Simulation Analysis and Setup.

Finite-element simulations were performed to compare coplanar and parallel electrode configurations and to evaluate the position dependence of the measured impedance signal.

A two-dimensional electrostatic FEM model was implemented to represent the cross-section of the sensing region. The simulated geometry matched the fabricated device, with a 20-μm channel height and 20-μm electrode spacing for the parallel configuration. For the coplanar configuration, electrodes were placed on the same channel wall with identical spacing. The sensing circuit was modeled using a differential measurement scheme, consisting of a reference electrode and two sensing electrodes corresponding to the positive and negative inputs of a differential amplifier. The simulated output signal represents the differential voltage change produced when a particle perturbs the electric field in the sensing region.

The suspending medium was modeled as phosphate-buffered saline (PBS), and simulations were performed at an excitation frequency of 550 kHz, consistent with experimental conditions. The particle was modeled as a circular cell consisting of cytoplasm and membrane layers with representative electrical properties. To evaluate position dependence, the particle was translated laterally across the channel from-2.5 μm to +2.5 μm relative to the channel center, and the resulting impedance signal was recorded at each position. Because the electrode length is much larger than the channel height, a 2D cross-sectional model provides an accurate representation of the sensing region.

### Electric Field Distribution.

FIG. 7D, subpanel A and FIG. 7D, subpanel B each show the electric field magnitude for the coplanar and parallel electrode configurations, respectively.

In the coplanar configuration (FIG. 7D, subpanel A), the electric field is concentrated near the electrode edges and decays rapidly away from the surface. As a result, particles located at different heights within the channel experience significantly different electric field strengths.

In contrast, the parallel electrode configuration (FIG. 7D, subpanel B) produces a more uniform electric field across the channel height, consistent with a parallel-plate geometry. The field lines are distributed more evenly throughout the sensing region, indicating reduced sensitivity to particle position.

Position Dependence of the Signal. To evaluate the effect of particle position, the simulated cell was translated laterally across the channel while the differential signal was recorded. FIG. 7D, subpanel C and FIG. 7D, subpanel D each show the simulated signal waveforms for several particle trajectories at different lateral positions. In the coplanar configuration (FIG. 7D, subpanel C), the signal amplitude and waveform vary significantly as the particle position changes. This variation occurs because particles experience different local electric field strengths depending on their location relative to the electrode edges.

In contrast, the parallel electrode configuration (FIG. 7D, subpanel D) shows substantially smaller variation in the signal waveform as the particle position changes, indicating improved position-independent sensing.

### Size Dependence of the Signal.

To evaluate size sensitivity, particles with diameters of 5 μm, 7.5 μm, and 10 μm were simulated. FIG. 7D, subpanel E and FIG. 7D, subpanel F show the peak signal amplitudes measured for each particle size as a function of particle position. For the coplanar electrode configuration (FIG. 7D, subpanel E), signal amplitude varies significantly with particle position, and the signals produced by different particle sizes overlap in some regions of the channel. This overlap can obscure size differences and reduce measurement accuracy.

In contrast, the parallel electrode configuration (FIG. 7D, subpanel F) shows a more consistent relationship between particle size and signal amplitude. Across all simulated positions, the signals produced by 10-μm particles remain larger than those from 7.5-μm and 5-μm particles, indicating improved size-dependent sensing.

### Summary of Simulation Results.

The simulations demonstrate that (i) parallel electrodes produce a more uniform electric field in the sensing region, (ii) the differential impedance signal is less sensitive to particle position, and (iii) signal amplitude scales more consistently with particle size. These results support the use of parallel electrode configurations for position-independent impedance sensing in plastic microfluidic devices.

### Electrical Measurement and Signal Analysis.

FIG. 7E shows the overall measurement workflow and analysis pipeline. Electrical measurements were performed using a differential impedance sensing system combined with lock-in detection. Specifically, FIG. 7E, subpanel A shows the experimental setup employed in the study. Particles flowing through the sensing region perturb the electric field between the opposing electrodes, producing a transient impedance signal. An AC excitation signal is applied to the device, and the resulting current is converted to a voltage using a transimpedance amplifier (TIA). The amplified signal is then demodulated using a lock-in amplifier (LIA) operating at the excitation frequency. This approach enables sensitive detection of small impedance variations while suppressing broadband noise. The lock-in amplifier provides synchronized demodulation of the signal, producing time-series streams corresponding to the measured electrical response of particles passing through the sensing region.

### Event Detection and Feature Extraction.

The recorded signal stream is processed to detect individual particle events and extract quantitative features from each event.

As shown in FIG. 7E, subpanel B, a segmentation algorithm is used to identify transient signal regions corresponding to particle passages through the sensing region. Once candidate events are detected, individual signal segments are isolated and analyzed. For each event, the peak amplitude relative to the baseline level is calculated. This amplitude corresponds to the maximum perturbation of the electric field produced as the particle traverses the sensing region and serves as the primary feature used for particle characterization.

### Population Analysis.

The extracted signal amplitudes from multiple particle events are used to construct amplitude distributions. In FIG. 7E, subpanel C, the amplitude histogram shows distinct clusters corresponding to different particle populations. These distributions enable statistical analysis of particle signals and allow differentiation between particles with different sizes or electrical properties. This signal-processing framework converts continuous electrical recordings into discrete particle events and provides quantitative features that are used for the bead experiments described in the following section.

### Bead Characterization Experiments.

To validate the electrical functionality of the fabricated parallel-electrode device and verify that the measured signal is primarily dependent on particle volume rather than particle position within the channel, polystyrene microspheres of known diameters were used as calibration particles.

FIG. 7E shows the resulting impedance perturbations recorded through the transimpedance amplifier and lock-in demodulation chain. Polystyrene beads with nominal diameters of 10 μm and 4.2 μm were suspended in phosphate-buffered saline (PBS) containing 1% bovine serum albumin (BSA) to reduce particle aggregation and minimize nonspecific adsorption to the channel surfaces. The suspension was introduced into the microfluidic channel while the device was excited with a sinusoidal voltage signal.

As each bead passed through the sensing region, a transient change in the demodulated amplitude signal was observed. FIG. 7F shows the peak amplitude of each event was extracted from the time-domain traces and used as the primary metric for comparison between particle populations.

FIG. 7G shows a histogram of the extracted peak amplitudes for each bead size. The distributions corresponding to the two bead populations exhibit distinct mean values, with the 10 um beads producing significantly larger signal amplitudes than the 4.2 μm beads. This observation is consistent with the theoretical expectation that the impedance perturbation generated by a particle in a conductive medium scales approximately with the volume of the particle. To visualize the separation between bead populations, normalized distributions of the extracted peak amplitudes were overlaid (FIG. 7G). The resulting distributions demonstrate clear separation between the two bead sizes with minimal overlap, indicating that the device can reliably distinguish particles based on size. These results confirm that the parallel-electrode sensing configuration produces signals that strongly correlate with particle volume while maintaining relatively low sensitivity to lateral particle position within the channel. This characteristic is critical for reliable particle and cell characterization in microfluidic impedance sensing systems.

### CONCLUSION

The construction and arrangement of the systems and methods, as shown in the various implementations, are illustrative only. Although only a few implementations have been described in detail in this disclosure, many modifications are possible (e.g., variations in sizes, dimensions, structures, shapes, proportions of the various elements, values of parameters, mounting arrangements, use of materials, colors, orientations, etc.). For example, the position of elements may be reversed or otherwise varied, and the nature or number of discrete elements or positions may be altered or varied. Accordingly, all such modifications are intended to be included within the scope of the present disclosure. The order or sequence of any process or method steps may be varied or re-sequenced according to alternative implementations. Other substitutions, modifications, changes, and omissions may be made in the design, operating conditions, and arrangement of the implementations without departing from the scope of the present disclosure.

The present disclosure contemplates methods, systems, and program products on any machine-readable media for accomplishing various operations. The implementations of the present disclosure may be implemented using existing computer processors, or by a special purpose computer processor for an appropriate system, incorporated for this or another purpose, or by a hardwired system. Implementations within the scope of the present disclosure include program products, including machine-readable media for carrying or having machine-executable instructions or data structures stored thereon. Such machine-readable media can be any available media that can be accessed by a general-purpose or special-purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures, and which can be accessed by a general purpose or special purpose computer or other machine with a processor.

When information is transferred or provided over a network or another communications connection (either hardwired, wireless, or a combination of hardwired or wireless) to a machine, the machine properly views the connection as a machine-readable medium; thus, any such connection is properly termed a machine-readable medium. Combinations of the above are also included within the scope of machine-readable media. Machine-executable instructions include, for example, instructions and data that cause a general-purpose computer, special-purpose computer, or special-purpose processing machine to perform a certain function or group of functions.

It is to be understood that the methods and systems are not limited to specific synthetic methods, specific components, or to particular compositions. It is also to be understood that the terminology used herein is for the purpose of describing particular implementations only and is not intended to be limiting.

As used in the specification and the appended claims, the singular forms “a,” “an” and “the” include plural referents unless the context clearly dictates otherwise. Ranges may be expressed herein as from “about” one particular value, and/or to “about” another particular value. When such a range is expressed, another implementation includes from the one particular value and/or to the other particular value. Similarly, when values are expressed as approximations, by use of the antecedent “about,” it will be understood that the particular value forms another implementation. It will be further understood that the endpoints of each of the ranges are significant both in relation to the other endpoint, and independently of the other endpoint.

“Optional” or “optionally” means that the subsequently described event or circumstance may or may not occur and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other additives, components, integers or steps. “Exemplary” means “an example of” and is not intended to convey an indication of a preferred or ideal implementation. “Such as” is not used in a restrictive sense but for explanatory purposes.

Disclosed are components that can be used to perform the disclosed methods and systems. These and other components are disclosed herein, and it is understood that when combinations, subsets, interactions, groups, etc. of these components are disclosed while specific reference of each various individual and collective combinations and permutation of these may not be explicitly disclosed, each is specifically contemplated and described herein, for all methods and systems. This applies to all aspects of this application, including, but not limited to, steps in disclosed methods. Thus, if there are a variety of additional steps that can be performed it is understood that each of these additional steps can be performed with any specific implementation or combination of implementations of the disclosed methods.

The following patents, applications, and publications, as listed below and throughout this document, are hereby incorporated by reference in their entirety herein.

What is claimed:

1. A multi-layer microfluidic device comprising:
a polymer substrate having a surface or a channel surface comprising at least two metal electrodes lithographically patterned thereon, including a first electrode and a second electrode, wherein the first electrode and the second electrode are formed of one or more metal layers deposited on the polymer substrate and lithographically patterned and etched to have etched electrode features having less than 10 μm in size; and
a microfluidic portion fixably coupled to the polymer substrate to form the multi-layer microfluidic device, the microfluidic portion having a set of channels and patterns formed via a molding process to form (i) a plurality of microfluidic channels and (ii) one or more internal volumes defining one or more chambers, including a first chamber, wherein the first chamber has chamber structures,
wherein the first electrode is disposed at an inlet of the first chamber, and wherein the second electrode is disposed at an outlet of the first chamber.

2. The multi-layer microfluidic device of claim 1, wherein the first electrode and the second electrode each comprise a metal stack comprising two or more metals.

3. The multi-layer microfluidic device of claim 1, wherein the first electrode is connected via a first tracing to a first electrode pad all formed of the one or more metal layers deposited on the polymer substrate and lithographically patterned and etched to form the first tracing and the first electrode pad, and wherein the second electrode is connected via a second tracing to a second electrode pad all formed of the one or more metal layers deposited on the polymer substrate and lithographically patterned and etched to form the second tracing and the second electrode pad.

4. The multi-layer microfluidic device of claim 1, wherein the first chamber includes antibody-functionalized micropillars to (i) selectively immobilized a target cell, as the chamber structures functionalized for cell capture, cell sorting, or immunophenotyping when a sample, comprising target and non-target cells, flows through the first chamber, and wherein the first electrode disposed at the inlet of the first chamber and the second electrode disposed at the outlet of the first chamber are each configured to be interrogated, by an electric circuit, to provide a first impedance-based measurement and a second impedance-based measurement in an impedance-based counting operation.

5. The microfluidic device of claim 1, wherein the chamber structures are functionalized by a biomolecule selected from the group consisting of avidin, thiol, cyclooctyne, polydopamine/protein G, azide, and a combination thereof.

6. The microfluidic device of claim 1, wherein the polymer substrate is formed of a polymer selected from the group consisting of a polycarbonate (PC), a Cyclic Olefin Copolymer (COC), and a polyethylene tetraphthalate (PET).

7. The microfluidic device of claim 6, wherein the microfluidic portion is made of polymer selected from the group consisting of a polystyrene (PS), a polycarbonate (PC), a Cyclic Olefin Copolymer (COC).

8. The microfluidic device of claim 1, further comprising a second chamber,
wherein the polymer substrate includes a third electrode and a fourth electrode, wherein the third electrode and the fourth electrode are formed of one or more metal layers deposited on the polymer substrate and lithographically patterned and etched to have etched electrode features having less than 10 μm in size,
wherein the microfluidic portion, having the set of channels and patterns formed via the molding process, forms the second chamber,
wherein the third electrode is disposed at an inlet of the second chamber, and wherein the fourth electrode is disposed at an outlet of the second chamber.

9. The microfluidic device of claim 8, wherein at least two of the first, second, third, and fourth electrodes are connected to one another via the first electrode pad and the second electrode pad for multiplexed interrogation of cells in the sample for multiplexed counting.

10. The microfluidic device of claim 1, wherein the first chamber and a second chamber are configured in a series configuration, a parallel configuration, or a combination of both series and parallel configurations.

11. The microfluidic device of claim 1, wherein at least one of the first electrode and the second electrode is measure electrical properties and mechanical properties of cells of the sample.

12. The microfluidic device of claim 1, further comprising an array of chambers, including the first chamber,
wherein the polymer substrate includes an upstream electrode and a downstream electrode for each chamber of the array of chambers, wherein each upstream electrode and each downstream electrode for each respective chamber of the array of chambers are formed of one or more metal layers deposited on the polymer substrate and lithographically patterned and etched to have etched electrode features having less than 10 μm in size.

13. The microfluidic device of claim 1, wherein the first electrode and the second electrode are formed of one or more metal layers deposited on the polymer substrate and lithographically patterned and etched via use of a positive photoresist and UV curing process.

14. The microfluidic device of claim 1, wherein the microfluidic portion is formed of a molding process selected from the group consisting of hot embossing, injection molding, and compression molding.

15. The microfluidic device of claim 1, wherein the first electrode comprises a set of electrode portions, wherein electrode spacings or spacings between the electrode portions, as the electrode features, are lithographically patterned and etched to have etched electrode features having less than 10 μm in size.

16. A method of fabricating a multi-layer polymer microfluidic device comprising:
forming a polymer substrate having a surface or a channel surface comprising at least two metal electrodes lithographically patterned thereon, including a first electrode and a second electrode, wherein the first electrode and the second electrode are formed of one or more metal layers deposited on the polymer substrate and lithographically patterned and etched to have etched electrode features having less than 10 μm in size, the forming comprising:
(i) depositing the one or more metal layers on the polymer substrate as a workpiece;
(ii) applying a photoresist over a top surface of one or more metal layers of the workpiece;
(iii) lithographically patterning the photoresist to define the at least two metal electrodes lithographically patterned on the surface or a channel surface of the workpiece;
(iv) wet etching the workpiece to at least define the first electrode and the second electrode; and
(iv) applying ultraviolet flood exposure to remove the photoresist without use of a solvent or plasma; and
forming, via a molding process, a microfluidic portion having a set of channels and patterns; wherein the molding process is selected from the group consisting of hot embossing, injection molding, and compression molding; and
fixably coupling the polymer substrate and the microfluidic portion to form the multi-layer microfluidic device, wherein the polymer substrate and the microfluidic portion couple to form (i) a plurality of microfluidic channels and (ii) one or more internal volumes defining one or more chambers, including a first chamber, wherein the first chamber has chamber structures functionalized for cell capture, cell sorting, or immunophenotyping of a sample, and wherein the first electrode is disposed at an inlet of the first chamber, and wherein the second electrode is disposed at an outlet of the first chamber.

17. The method of claim 16, wherein the applied photoresist is a positive photoresist that is sensitive to ultraviolet light.

18. The method of claim 16 further comprising:
prior to fixably coupling the polymer substrate and the microfluidic portion to form the multi-layer microfluidic device, applying a biomolecule to the chamber structures functionalized for cell capture, cell sorting, or immunophenotyping,
wherein the biomolecule is selected from the group consisting of avidin, thiol, cyclooctyne, polydopamine/protein G, azide, and a combination thereof.

19. The method of claim 16, wherein the first electrode and the second electrode each comprise a metal stack comprising two or more metals.

20. The method of claim 16, wherein the polymer substrate is formed of a polymer selected from the group consisting of a polycarbonate (PC), a Cyclic Olefin Copolymer (COC), and a polyethylene tetraphthalate (PET), and wherein the microfluidic portion is made of polymer selected from the group consisting of a polystyrene (PS), a polycarbonate (PC), a Cyclic Olefin Copolymer (COC).
